(19) United States
(12) Patent Application Publication
(10) Pub. No.: US 2010/0033106 A1
(43) Pub. Date: Feb. 11, 2010

(54) HIGH-PRESSURE DISCHARGE LAMP, HIGH-PRESSURE DISCHARGE LAMP LIGHTING SYSTEM AND LIGHTING EQUIPMENT

(75) Inventors: Masazumi ISHIDA, Yokosuka-shi (JP); Takahito Kashiwagi, Yokosuka-shi (JP); Kozo Uemura, Yokosuka-shi (JP); Yuichiro Takahara, Yokosuka-shi (JP); Noriyuki Kitamura, Hadano-shi (JP)

Correspondence Address: DLA PIPER LLP US, P. O. BOX 2758, RESTON, VA, 20195, US

(73) Assignee: TOSHIBA LIGHTING & TECHNOLOGY CORPORATION, Yokosuka-shi (JP)

(21) Appl. No.: 12/536,730

(22) Filed: Aug. 6, 2009

(30) Foreign Application Priority Data
Aug. 8, 2008 (JP) 2008-206299
Sep. 22, 2008 (JP) 2008-242551
Dec. 19, 2008 (JP) 2008-323477
Dec. 25, 2008 (JP) 2008-329426

(51) Int. Cl. H05B 41/16; H01J 61/12

(52) U.S. Cl. 315/287; 313/570

(57) ABSTRACT

Disclosed is a high-pressure discharge lamp includes a translucent ceramics sealed container provided with an enclosed part with a discharge space formed therein, a pair of electrodes disposed inside of both end parts of the translucent sealed container, an ionization medium having a structure containing a metal halide that primarily emits light, a starting gas and substantially no mercury, the metal halide that primarily emits light including 30% by mass or more of a halide of at least one lanthanoid type rare earth metal and the starting gas having a pressure P (atm) satisfying the equation, 1≦P≦20, the ionization medium being sealed in the translucent ceramics sealed container, wherein the ratio D/G satisfies the equation, 0.3≦D/G≦2.4 when the maximum inside diameter of the translucent ceramics sealed container is D and the inter-electrode distance is G.

### CROSS-REFERENCE TO RELATED APPLICATIONS

This application is based upon and claims the benefit of priority from prior Japanese Patent Applications No. 2008-206299, filed Aug. 8, 2008; No. 2008-242551, filed Sep. 22, 2008; No. 2008-323477, filed Dec. 19, 2008; and No. 2008-329426, filed Dec. 25, 2008, the entire contents of all of which are incorporated herein by reference.

### BACKGROUND OF THE INVENTION

1. Field of the Invention

The present invention relates to a high-pressure discharge lamp which can be toned and is free from mercury, a high-pressure discharge lamp lighting system and a lighting equipment provided with the high-pressure discharge lamp.

2. Description of the Related Art

It has been known that the toning characteristics of a high-pressure discharge lamp with mercury are improved by sealing either no thallium (Tl) halide or a limited minute amount of thallium (Tl) halide and magnesium (Mg) halide (see, for example, Japanese Patent No. 3965948). Also, it is also known that a starting auxiliary conductor called the proximity conductor is disposed outside of a luminescent tube as the starting auxiliary means of a high-pressure discharge lamp (for example, Jpn. Pat. Appln. KOKAI Publication No. 2002-063992).

Because mercury is a material which has the possibility of environmental pollution, it has been recently desired to reduce the amount of mercury to be used.

### BRIEF SUMMARY OF THE INVENTION

The inventors of the present invention have researched and studied a high-pressure discharge lamp which is, though it is freed of mercury, superior in toning characteristics and luminous efficacy, and as a result, found that a desired high-pressure discharge lamp can be obtained by designing the sealing pressure of the starting gas and ionization medium and structure of a luminescent tube in each specified range, to complete the present invention.

It is an object of the present invention to provide a high-pressure discharge lamp which is freed of mercury and is superior in toning characteristics and luminous efficacy and lighting equipment provided with this high-pressure discharge lamp.

A high-pressure discharge lamp (first invention) of the present invention includes a translucent ceramics sealed container provided with an enclosed part with a discharge space formed therein; a pair of electrodes disposed inside of both end part of the translucent sealed container; an ionization medium having a structure including a metal halide that primarily emits light, a starting gas and substantially no mercury, the metal halide that primarily emits light including 30% by mass or more of a halide of at least one lanthanoid type rare earth metal and the starting gas having a pressure P (atm) satisfying the equation, 1≦P≦20, the ionization medium being sealed in the translucent ceramics sealed container, wherein the ratio D/G satisfies the equation, 0.3≦D/G≦2.4 when the maximum inside diameter of the translucent ceramics sealed container is D and the inter-electrode distance is G.

A high-pressure discharge lamp lighting system (second invention) of the present invention includes the high-pressure discharge lamp; a lighting circuit provided with a pair of output terminals of which one is a stable potential side and the other is an unstable potential side wherein the stable potential side output terminal is connected to a first electrode of the high-pressure discharge lamp and the unstable potential side output terminal is connected to a second electrode to light the high-pressure discharge lamp.

A high-pressure discharge lamp lighting system (third invention) of the present invention includes the high-pressure discharge lamp; a lighting circuit provided with an AC voltage generating circuit and a pair of output terminals which output AC voltage to apply the voltage across a first electrode and a second electrode of the high-pressure discharge lamp, thereby lighting the high-pressure discharge lamp; and a pulse voltage generating circuit which generates pulse voltage having a polarity inverse to that of AC voltage synchronously with the AC output voltage of the lighting circuit at the start of the high-pressure discharge lamp to apply the pulse voltage to the high-pressure discharge lamp.

Lighting equipment (fourth invention) of the present invention includes a lighting equipment body; the high-pressure discharge lamp, the discharge lamp being disposed in the lighting equipment body; and a high-pressure discharge lamp lighting device which has the function of generating starting high voltage at the start of lighting to start and to light the high-pressure discharge lamp.

According to the first invention, a high-pressure discharge lamp can be provided which has superior toning characteristics and a high luminous efficacy because the correlated color temperature is scarcely changed even if lamp power is changed, and also lighting equipment having the high-pressure discharge lamp can be provided.

According to the second invention, the first electrode connected with the starting auxiliary conductor of the high-pressure discharge lamp is connected to the stable potential side output terminal among the paired output terminals of the lighting circuit and the second electrode disposed opposite to the starting auxiliary conductor via a translucent sealed container is connected to the unstable potential side output terminal. This causes strong creeping discharge on the inner surface of the translucent sealed container facing the proximity conductor when the lamp starts, and therefore, a mercury-free high-pressure discharge lamp lighting system can be provided which is improved not only in startability but also in the simplicity of circuit structure and also, lighting equipment provided with this lighting system can be provided.

According to the third invention, a pulse voltage having a polarity inverse to that of the AC voltage to be applied to the paired electrode of the high-pressure discharge lamp is applied when the lamp starts. This causes strong creeping discharge on the inner surface of the translucent sealed container facing the proximity conductor, and therefore, a mercury-free high-pressure discharge lamp lighting system can be provided which is improved not only in startability but also in the simplicity of circuit structure and also, lighting equipment provided with this lighting system can be provided.

### BRIEF DESCRIPTION OF THE SEVERAL VIEWS OF THE DRAWINGS

FIG. 1 is a sectional view of a luminescent tube showing an embodiment of a high-pressure discharge lamp according to the present invention;

FIG. 2 is a characteristic diagram showing the relation between the lamp power and color temperature of a high-pressure discharge lamp in the present invention and in Comparative Example;

FIG. 3 is a characteristic diagram showing the relation between the seal pressure of starting gas, starting voltage and luminous efficacy in the present invention;

FIG. 4 is a front view of a high-pressure discharge lamp according to a second embodiment of the present invention;

FIG. 5 is a sectional view showing an ultraviolet enhancer which is one structure of the high-pressure discharge lamp of FIG. 4;

FIG. 6 is a sectional view schematically showing a luminescent tube and an ultraviolet enhancer which are respectively a structure of the high-pressure discharge lamp of FIG. 4;

FIG. 7 is a sectional view showing a recessed type ceiling down light according to a third embodiment of the present invention;

FIG. 8 is a block circuit diagram for explaining a high-pressure discharge lamp lighting system according to a fourth embodiment of the present invention;

FIG. 9 is a graph showing each starting voltage of a high-pressure discharge lamp according to the present invention and a high-pressure discharge lamp of Comparative Example;

FIG. 10 is a block circuit diagram for explaining a high-pressure discharge lamp lighting system according to a fifth embodiment of the present invention;

FIG. 11 is a block circuit diagram for explaining a high-pressure discharge lamp lighting system according to a sixth embodiment of the present invention; and

FIG. 12 is a graph showing the results when high-pressure discharge lamps variously changed in the seal pressure of starting gas and in inter-electrode distance are manufactured based on one embodiment of the present invention to measure the correlation between the seal pressure of the starting gas and the inter-electrode distance and the relation between the starting voltage and luminous efficacy.

### DETAILED DESCRIPTION OF THE INVENTION

A high-pressure discharge lamp according to the first invention of the patent application of this case is, as mentioned above, provided with a translucent ceramics sealed container and a pair of electrodes, wherein the pressure P (atm) of starting gas satisfies the equation, 1≦P≦20 and the ratio D/G satisfies the equation, 0.3≦D/G≦2.4 when the maximum inside diameter of the sealed container is D and the inter-electrode distance is G.

The present invention permits the following aspects.

The above sealed container means a sealed container in which at least the major part that leads the radiation generated in a discharge space formed inside thereof out of the container is made of translucent ceramics and is formed using an anti-flammable ceramic raw material which stands to usual working temperatures. The use of the above ceramics sealed container ensures that the temperature of the coldest part is set to be higher than that of the sealed container made of quartz glass, making it possible to make lamp voltage higher and also to improve the luminous efficacy.

Also, the translucent ceramics sealed container is highly durable to lanthanoid type rare earth metals or their halides in the ionization medium and is therefore convenient when a lanthanoid type rare earth metal halide is used as an ionization medium. In this case, as the translucent ceramics, polycrystalline or monocrystal ceramics of translucent alumina, yttrium-aluminum-garnet (YAG) or yttrium oxide (YOX) and polycrystalline non-oxide, for example, aluminum nitride (AlN) may be used.

On the other hand, the translucent ceramics sealed container is provided with at least an enclosed part that surrounds the discharge space inside thereof. The enclosed part has its inner space having an adequate shape, for example, a spherical form, spheroidal form, or cylinder-like form. As the volume of the inner space, various values may be selected corresponding to the rated lamp power and inter-electrode distance of the high-pressure discharge lamp. The volume of the inner space may be designed to be 1.0 cc or less in the case of, for example, a liquid crystal projector lamp and 0.05 cc or less in the case of a lamp for an automobile headlight. Also, in the case of general lighting lamps, the volume of the inner space may be designed to be any of a volume of 1 cc or more or a volume of 1 cc or less corresponding to the rated lamp power. Moreover, if the maximum inside diameter of the translucent ceramics sealed container is designed to be 4 to 17 mm, preferably 4 to 7 mm in the case of 100 W class lamp power and 3 to 5 mm in the case of 35 W class lamp power, it is effective to keep high temperature of the coldest part to thereby maintain high luminous efficacy even if the inter-electrode distance is increased to obtain proper lamp voltage. The term “100 W class” means a lamp power range from 100 to 250 W. Also, the term “35 W class” means a lamp power range from 20 to 75 W.

Moreover, the translucent ceramics sealed container may include a small-diameter cylinder part communicated with the enclosed part. The small-diameter cylinder part seals the enclosed part, and also contributes to the airtight introduction of current into the electrode from a lighting circuit through a current introducing conductor in which the axis part on the electrode base end side is penetrated through the inside of the enclosed part and a part of the axis part is penetrated through the inside of the small-diameter cylinder part. Then, generally, the small-diameter cylinder part is disposed on each end of the enclosed part.

As the means for sealing the translucent ceramics sealed container, there are various seal means, for example, flit sealing in which flit glass is poured into a space between the translucent ceramics and the introduction conductor to seal the container, metal sealing using a metal in place of the flit glass and a method in which the opening part of the translucent ceramics sealed container to be sealed is melted to bind the opening part directly or indirectly with the current introducing conductor to seal. In the present invention, these various means may be selectively adopted as desired.

Also, the small-diameter cylinder part communicated with the enclosed part can be designed to have a length fit to its object in order to keep a desired relatively high temperature as the coldest part temperature of the discharge space formed in the translucent sealed container while the sealed part formed using the flit glass of the translucent ceramics sealed container is kept at a desired relatively low temperature. In this case, the sealed part is formed at the end part of the small-diameter cylinder part and the electrode axis part is extended into the small-diameter cylinder part to form a small clearance, that is, a capillary along the axis direction of the small-diameter cylinder part between the electrode axis part or/and the current introducing conductor and the inner surface of the small-diameter cylinder part. The electrode axis part is not in the state in which only the electrode axis present but includes a coil with a capillary formed around the coil when the electrode is provided with an electrode axis coil formed by coiling fine wire made of the same material as the electrode around the electrode axis.

Moreover, the translucent ceramics sealed container may be formed by separately molding the enclosed part and small-diameter cylinder part, which are integrated with each other by adopting the shrinkage fitting, or by integrating the both from the start. In the case of the integrated translucent ceramics sealed container, the distribution of its wall thickness is easily uniformed and therefore, a structural shape may be adopted in which the enclosed part and the small-diameter cylinder part are combined by a continuous curve. Therefore, the distribution of temperature is easily uniformed and optical homogeneity is easily obtained, which is preferable.

In the present invention, the maximum inside diameter. D (mm) of the enclosed part of the translucent ceramics sealed container is designed such that the ratio of the maximum diameter D (mm) to the inter-electrode distance G (mm) falls in a specified range as described later. Also, in addition to the above, the translucent ceramics sealed container preferably has an aspect in which when its internal volume, that is, the internal volume of the enclosed part is V (cc) and the sealing amount of a metal halide that primarily emits light in the ionization medium which will be explained later is M (mg), the ratio M/V is designed to be in a specified range. Moreover, in the case where the translucent ceramics sealed container has the structure in which a capillary is formed inside of the small-diameter cylinder part, the capillary filling ratio U which is the proportion of halides put into a liquid phase in the capillary when the lamp is turned on is in a specified range which will be explained later, in a preferred aspect.

The pair of electrodes are disposed in the inside of both ends of the enclosed part of the translucent ceramics sealed container and the interval between the ends of these electrodes is the inter-electrode distance G (mm). As to the structural material of the electrodes, metals having anti-flammability and conductivity, for example, pure tungsten (W), doped tungsten containing doping agents (one or more types selected from the group consisting of, for example, scandium (Sc), aluminum (Al), potassium (K) and silicon (Si)), thoriated tungsten containing thorium oxide, rhenium (Re) or tungsten-rhenium (W—Re) alloy may be used to form these electrodes.

In the case of a small high-pressure discharge lamp, a straight bar-like wire materials or wire material with a larger diameter part formed at its end may be used as the electrodes. In the case of electrodes to be used in a middle to large high-pressure discharge lamp, a coil made of electrode structural material may be wound at the top of the electrode axis. The paired electrodes are designed to have the same structure when operated under AC current. However, in the case of operating under DC current, a rise in the temperature of the anode is significant in general and therefore, a material having a larger radiation area than that of the cathode and hence thick main part may be used as the anode.

Also, because the base end of the electrode is supported by the current introducing conductor sealed air-tightly in the translucent ceramics sealed container, the electrode main part of the end part is fixed to a prescribed position in the enclosed part. When the small-diameter cylinder part is formed in the translucent ceramics sealed container, a structure is permitted in which the electrode axis part between the electrode main part and the base end is positioned and extended on the center axis of the small-diameter cylinder part and disposed so as to form a capillary between the inner surface of the small-diameter cylinder part and the outer surface of the electrode axis part.

Moreover, the electrode may have a structure in which an electrode axis coil made of fine wire of the aforementioned electrode structural materials, for example, tungsten or molybdenum is wound around its axis part. In this aspect, the capillary is formed mainly between the outer peripheral surface of the electrode axis coil and the inner surface of the small-diameter cylinder part. However, when a clearance exists between coil turns, a structure in which the clearance also functions as the capillary may be adopted. The arrangement of the electrode axis coil increases the heat capacity of the electrode axis and therefore, the temperature of the electrode axis is dropped to thereby limit the reaction between the metal halide and the electrode axis, making it possible to prolong the life of the high-pressure discharge lamp.

In the present invention, the ratio D/G of the maximum inside diameter D of the translucent ceramics sealed container to the inter-electrode distance G is designed in the range satisfying the equation, 0.3≦D/G≦2.4. When this requirement is fulfilled, the discharge starting voltage is relatively low, color separation is scarcely caused and a desired high lamp voltage is obtained, leading to a high luminous efficacy. When the ratio D/G is less than 0.3 on the other hand, the discharge starting voltage and hence starting voltage becomes high and color separation is easily caused. Also, when the ratio D/G exceeds 2.4, it is difficult to obtain a desired lamp voltage and luminous efficacy. The ratio D/G is more preferably as follows: 0.4≦D/G≦1.8. If the ratio is in this range, high lamp voltage, high luminous efficacy and also, good startability and long life can be exactly secured.

The ionization medium contains at least a halide of a metal that primarily emits light and starting gas and contains substantially no mercury. In this case, the metal that primarily emits light means a metal in charge of light emission which contributes to at least a major part among the major part of the spectrum of the emitted light. This metal may have, in addition to the light emission, a function of forming lamp voltage.

In the present invention, the halide of a metal that primarily emits light includes a halide of a lanthanoid type metal as its major component. The lanthanoid type metal is constituted of the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu). These lanthanoid type metals each radiate many bright line spectrums along the luminosity characteristic curve and are therefore luminous metals effective to improve luminous efficacy.

Especially, thulium (Tm) radiates many bright line spectrums in the vicinity of the peak wavelength of the luminosity characteristic curve and its peak of emitted light coincides with the peak of the luminosity characteristic curve. Therefore, thulium is a metal which primarily emits light and is very effective to improve the luminous efficacy in the present invention. Also, thulium works to raise lamp voltage in a mercury-free aspect and is therefore useful in the present invention. It is to be noted that holmium also has a nature similar to that of thulium.

Also, the ratio of the halide of a lanthanoid type metal to be sealed is limited to 30% by mass or more and preferably 50% by mass or more based on the total amount of the halide of all of metals which primarily emit light. If the ratio of the lanthanoid type metal halide to be sealed is 50% by mass or more, a higher lamp voltage and a higher luminous efficacy can be obtained. However, if the above ratio of the halide to be sealed exceeds 80% by mass, the room of halides of metals other than lanthanoid type rare earth metals, for example, thulium (Tm) and holmium (Ho) to be sealed is reduced correspondingly, with the result that no desired emission of white light is obtained, which is undesirable for the purpose of obtaining emission of white light. Therefore, the upper limit of the amount of these lanthanoid type rare earth metals is preferably designed to be 80% by mass or less.

When the ratio of the lanthanoid type rare earth metals to be sealed is 80% by mass or less, halides of metals which primarily emit light other than lanthanoid type metals are allowed to be sealed in a remainder range of 20 to 70% by mass to obtain a desired luminescent color or chromaticity. For example, in the case of intending to obtain white light emission, a halide of sodium (Na) and the like is allowed to be sealed. Also, a halide of indium (In) may be sealed in a proper amount to adjust luminescent chromaticity and color temperature. Incidentally, because indium halides have a high vapor pressure, it has the ability of forming lamp voltage.

However, in the present invention, thallium (Tl) is not sealed in substance because it impairs the toning characteristics. In other words, it is desirable that no thallium be sealed at all. Even in the case of sealing thallium, it is necessary to seal thallium in a small ratio at an impurity level.

Also, in the present invention, a halide of a metal effective to primarily form lamp voltage may be sealed in addition to the halide of a metal which primarily emits light. Specifically, as the halide for primarily forming lamp voltage, one or plural types of halides selected from the group consisting of magnesium (Mg), iron (Fe), cobalt (Co), chromium (Cr), zinc (Zn), nickel (Ni), manganese (Mn), aluminum (Al), antimony (Sb), beryllium (Be), rhenium (Re), gallium (Ga), titanium (Ti), zirconium (Zr) and hafnium (Hf) may be used. Because these metals are reduced in light emission in the visible region and are hard to emit light when enclosed along halide which primarily emits light and because halides of these metals each have a relatively higher vapor pressure; they are superior in the ability to form lamp voltage as the characteristics common to them.

No particular limitation is imposed on the sealing amount of the halides of the metal effective to primarily form lamp voltage. However, though a higher lamp voltage can be obtained as the amount of the halide to be sealed is increased, a deviation of luminescent chromaticity is increased, or/and the luminous efficacy tends to drop and therefore, the amount of the halides is preferably as smaller as possible within the range necessary to obtain desired characteristics. Among lanthanoid type rare earth metals, thulium and holmium, as mentioned above, have the ability to raise lamp voltage in a mercury-free aspect besides excellent luminescent characteristics. Therefore, in the case of sealing these halides, a desired lamp voltage can be formed even if the sealing amount of the halide of the metal effective primarily to form lamp voltage is 0.1 to 10 mg per 1 cc of the internal volume of the translucent ceramics sealed container. If the amount is within this range, this is advantageous because the deviation of chromaticity is small. However, if the sealing amount is less than 0.1 mg, the desired lamp voltage forming action can not be obtained. Also, the sealing amount exceeds 10 mg, the deviation of luminescent chromaticity cannot be neglected though the desired lamp voltage can be obtained.

As the halogen used to form the halide of the metal which primarily emits light and the metal which primarily forms lamp voltage, iodine is preferable. However, bromine or chlorine may be used as desired.

The starting gas is sealed in the translucent sealed container such that the pressure P (atm) of the gas at ambient temperature satisfies the equation, 1≦P≦20. When the seal pressure is less than 1 atm, the luminous efficacy of the high-pressure discharge lamp becomes too low whereas when the seal pressure exceeds 20 atm, the starting voltage becomes too high, showing an amount out of the above range is unacceptable. The seal pressure is preferably 1 to 10 atm and more preferably 1 to 5 atm from the reason that a luminous efficacy of 90 lm/W or more is obtained and the starting voltage is 5 kV or less.

Also, as the starting gas, rare gases such as argon (Ar), krypton (Kr) and xenon (Xe) may be used independently or in combinations of two or more.

In the present invention, mercury is not sealed in substance, that is, mercury is not sealed. Also, even in the case of sealing mercury, it is necessary to seal mercury in a small ratio at an impurity level, for example, in an amount as small as 0.2 mg or less per internal volume of the translucent ceramics sealed container.

In the first aspect of the present invention, the ratio M/V of the amount M (mg) of all halides to be sealed to the internal volume V (cc) of the translucent ceramics sealed container may be so designed as to satisfy the equation, 3≦M/V≦8 as desired. If this requirement is satisfied, the coldest part temperature can be secured to the extent that desired lamp characteristics are obtained. If the ratio M/V is less than 3, it is difficult to secure the above coldest part temperature. If the ratio M/V exceeds 80, on the contrary, the amount of the halide to be stuck to the wall surface of the enclosed part becomes too large. Because the halide exhibits a yellowish green color, the luminescent color is easily affected by the optical filter action, leading to a large dispersion of luminescent characteristic if the amount of the halide to be stuck to the wall surface is increased. The M/V preferably satisfies the equation, 6≦M/V≦50.

In the case where the translucent ceramics sealed container is provided with a pair of small-diameter cylinder parts as a second aspect of the present invention, the capillary filling ratio U(%) which is the proportion of halides in the liquid phase filled inside of the capillary formed in at least one small-diameter cylinder part when the lamp is turned on preferably satisfies the equation, 0≦U≦95. Here, when the ionization medium includes halides of metals which primarily emit light and halides of metals which primarily form lamp voltage, the above halide includes all of these halides.

Then, if the capillary filling ratio U satisfies the above equation, a desired coldest part temperature can be obtained and also, the halides in the liquid phase filled inside of the capillary scarcely overflows undesirably toward the inner side of the enclosed part. For this, the liquid phase halides stuck to the inner side of the enclosed part function as a filter and therefore, variations in the luminescent characteristics of the high-pressure discharge lamp can be prevented. The volume of the capillary is defined as the volume of the clearance formed in the inner surface of the small-diameter cylinder part and around the electrodes and current introducing conductor in the part where the inside diameter of the small-diameter cylinder part is approximately fixed.

When the capillary filling ratio U is less than 75%, it is sufficiently practical but may be tend to be inefficient because the coldest part temperature becomes too low. When the capillary filling ratio U exceeds 95% on the contrary, the ionization medium in the liquid phase in which the halides overflow on the inner surface of the enclosed part easily produce an optical filter action on the radiation caused by discharge.

In a third aspect of the present invention, the width of the clearance between the inner surface of the small-diameter cylinder part and the outer peripheral surface of the electrode may be designed to be in a range from 10 to 80 μm in average and preferably 20 to 80 μm. The inner surface of the small-diameter cylinder part means the part where the inside diameter of the small-diameter cylinder part is approximately constant. If the width of the clearance is in this range, the halides placed in a liquid phase state during lighting are stably filled in the capillary, making it easy to form a desired coldest part temperature. When the width of the clearance is less than 10 μm, the halides are scarcely filled in the capillary, resulting in the overflow of the halides from the small-diameter cylinder part. When the width of the clearance exceeds 80 μm on the contrary, the filling ratio of the halides will increase and a liquid surface will lower, resulting in the drop of the coldest part temperature, or the amount of the halides required to obtain a certain coldest part temperature is increased, leading to an increase in the amount of impurities included in the halides.

In a fourth aspect of the present invention, the load on the tube wall is 15 to 25 W/cm².

As a fifth aspect of the present invention, there is provided s high-pressure discharge lamp further provided with a starting auxiliary conductor besides the above sealed container, the pair of electrodes and the ionization medium. Here, the starting auxiliary conductor is made of a heat resistant conductor. The starting auxiliary conductor unitarily including two ends and an intermediate portion between the two ends, one of the two ends being electrically connected to one of the electrodes of a luminescent tube having an enclosed part and two small-diameter cylinder parts oppositely extending from the enclosed part, the intermediate portion extending from the one of the electrodes over the enclosed part of the luminescent tube to the other of the electrodes, and the other end capacitively coupling to the other of the electrodes of the luminescent tube through one of the small-diameter cylinder parts enclosing the other of the electrodes. As to the position of the capacitive coupling part, the startability is better in the vicinity of the connecting position between the small-diameter cylinder part and the enclosed part, and the light distribution characteristics are scarcely hindered and the capacitive coupling part is easily determined at this position, showing that this position is desirable. An ultraviolet enhancer is disposed close to the side of the capacitive coupling part between the other electrode of the luminescent tube and the starting auxiliary conductor.

In the present invention, there is no particular limitation to the structure of the capacitive coupling part. It is however preferable to wind the other end part of the starting auxiliary conductor around the small-diameter cylinder part. As the heat resistant conductor, lead wires of conductive metals such as molybdenum, stainless steel and nickel or alloys of these metals may be used, and conductors called trigger wire or a conductive film primarily made of a conductive metal covered on the outside surface of the translucent ceramics sealed container are also allowed.

The ultraviolet enhancer is provided with the translucent ceramics sealed container, ionization medium and the pair of electrodes. As to the above sealed container, if it is at least a ultraviolet transmittable sealed container, no particular limitation is imposed on other structures. For example, borosilicate glass or quartz glass may be used. The ionization medium is sealed in the sealed container and serves as a discharge medium that radiates ultraviolet rays when dielectric barrier discharge or glow discharge occurs in the sealed container. The explanations of the above ionization medium are as mentioned above.

In the above fifth structure, the pair of electrodes may have any structure insofar as they are disposed so as to generate dielectric barrier discharge or glow discharge in the ionization medium sealed in the sealed container. However, they are preferably electrodes allowing the ionization medium to induce dielectric barrier discharge. Specifically, this means a structure in which for example, one electrode is disposed as the internal electrode in the sealed container and the other electrode is disposed as the external electrode so as to be in contact with the outside surface of an external enclosed container. In this structure, the wall surface of the external enclosed container at the part opposite to the external electrode is an equivalent circuit in which the electrostatic capacity of a dielectric intervenes in series in a lighting circuit of the ultraviolet enhancer. For this, an externally fitted ballast for the ultraviolet enhancer can be neglected. A structure in which the pair of electrodes are both external electrodes may be adopted according to the need. Also, a structure in which the pair of electrodes are both disposed in the sealed container in such a manner as to be apart from each other may be adopted. In this structure, a ballast for the ultraviolet enhancer is separately required to generate glow discharge between these electrodes.

Also, in the above fifth structure, no particular limitation is imposed on the material of the electrode. As the internal electrode, a material having electron radiating ability may preferably be used. As to the sealing of the sealed container, the electrode may be directly sealed in the sealed container if the internal electrode itself is conductive metal having high sealing ability. However, it is allowed to carry on works for the sealing of the sealed container and for the support of the internal electrodes simultaneously by using a seal metal such as a seal metal foil. The sealing of the internal electrodes and the connection of the current introducing conductor may be carried on by using a seal metal foil such as a Mo foil as desired.

On the other hand, the external electrode is free from such a problem concerning the sealing and therefore, may be a conductive metal having heat resistance. Also, the external electrode may be structured using a conductive structural material, such as, a mesh structure, that tends to transmit ultraviolet rays. Moreover, a structure may be adopted according to the need in which the external electrode doubles as a fitting means when its lead material is disposed in the high-pressure discharge lamp.

If the external electrode is made to have a mesh structure, the amount of radiation of ultraviolet rays from the ultraviolet enhancer can be increased. In this case, the mesh structure means that it is provided with a structure constituted of a woven metal wire, a coil, punching metal or a translucent conductive film formed with many voids.

Next, the positional relation between the starting auxiliary conductor and the ultraviolet enhancer will be explained. Specifically, the ultraviolet enhancer is disposed close to the side of the capacitive coupling part so as to strongly radiate the capacitive coupling part between the starting auxiliary conductor and the other electrode. Here, the term “the side of the capacitive coupling part” means that the side surface of at least a part of the luminescent length of the ultraviolet enhancer is almost exactly facing the capacitive coupling part. Also, the term “close” means that the outside surface of the ultraviolet enhancer is positioned at a distance of 10 mm or less from the outside surface of the capacitive coupling part. Here, the distance is preferably within 7 mm or less and more preferably within 5 mm or less. However, there may be a case that a distance of 10 mm or more is sufficiently practical.

If the aforementioned positional relation is satisfied, the capacitive coupling part can be irradiated with ultraviolet rays from the outside of the capacitive coupling part at a relatively high intensity because the ultraviolet enhancer has such light distribution characteristics that ultraviolet rays radiated toward the side surface side in the direction of the tube axis are increased. In this case, in an aspect in which the ultraviolet enhancer is provided with the external electrode having a mesh structure, the number of ultraviolet rays passing through the external electrode are more than those passing in other directions though some ultraviolet rays are absorbed when the ultraviolet rays pass through the external electrode.

In the high-pressure discharge lamp of the present invention, a part or all of the following structures may be added or combined as desired.

### 1. (Starting High-Voltage Applying Means)

Examples of the starting high-voltage applying means include an aspect in which a high-voltage pulse generator called “igniter” is combined with the high-pressure discharge lamp to apply a high-voltage pulse generated from the generator and an aspect in which when the high-pressure discharge lamp is turned on by using a stabilizer, so-called kick voltage generated from the stabilizer is applied as starting high-voltage to the luminescent tube from the outside of the high-pressure discharge lamp. Any of these aspects may be used as the starting high-voltage applying means. Also, as to the starting high-voltage generator such as an igniter, an aspect in which the generator is received in a case of the stabilizer, an aspect in which the generator is received in a cap and an aspect in which the generator is received in an external tube may be adopted. In order to generate the kick voltage, a starting switch such as a thermally driving switch and voltage driving switch may be disposed in the external tube of the high-pressure discharge lamp as needed.

### 2. (Rated Lamp Power of the High-Pressure Discharge Lamp)

In the present invention, the rated lamp power of the high-pressure discharge lamp can be freely designed in wide range. However, the rated power is preferably about 30 to 250 W. The high-pressure discharge lamp may be used in various fields and is preferably used for general lighting equipment. Therefore, the rated lamp power, the translucent ceramics sealed container having adequate shape and dimensions corresponding to use, proper inter-electrode distance, the type of ionization medium and its amount to be sealed and the seal pressure of the starting gas may be appropriately combined and a proper combination is selected.

### 3. (Protective Means Against the Rupture of the Luminescent Tube)

In the present invention, a known protective means may be used for the protection from the scatter of splinters generated when the luminescent tube of the high-pressure discharge lamp is ruptured. For example, a quartz glass cylinder called the “shroud” is disposed in the external tube so as to surround the luminescent tube primarily with the enclosed part of the translucent ceramics sealed container as its center. Or, the whole external tube may be further surrounded by a protective glass tube. Moreover, for example, the thickness of the glass is increased and a string-like materials made of a reinforcing metal or inorganic fiber may be wound around the shroud according to the need to satisfy the required explosion-proof characteristic when the luminescent tube is ruptured.

### 4. (Lighting Device of the High-Pressure Discharge Lamp)

A lighting device for a high-pressure discharge lamp to light the high-pressure discharge lamp of the present invention may be either a stabilizer primarily constituted of an iron core and a coil or a computerized lighting device. Also, the lighting device may be constituted of a lighting circuit that energizes the high-pressure discharge lamp to light and a starting high-voltage generator that generates starting high voltage to start the high-pressure discharge lamp. As the lighting circuit, various known lighting circuits may be adopted. A circuit structure primarily containing a rectangular wave AC generating circuit that preferably generates low-frequency rectangular wave AC voltage such as a full-bridge type inverter circuit or half-bridge type inverter circuit may be used. In place of this circuit or in addition to this circuit, a DC voltage converter circuit such as a boosting chopper and step-down chopper may be attached to a direct power source of an inverter circuit as a power voltage adjuster and/or as a device having an active filter function to use these circuits as a direct lighting device.

Then, when the power source of the lighting circuit that lights the high-pressure discharge lamp of the present invention is turned on, the starting high voltage is developed and applied to the high-pressure discharge lamp. When the starting high voltage is applied to the high-pressure discharge lamp, this voltage is applied across the pair of electrodes of the luminescent tube and at the same time, starting voltage is applied to the capacitive coupling part between the starting auxiliary conductor and the other electrode and to the ultraviolet enhancer, causing the is ultraviolet enhancer to work, whereby ultraviolet rays are radiated and centered on the above capacitive coupling part. When the above capacitive coupling part is irradiated with ultraviolet rays, initial electrons are discharged by photoelectric effect from the electrode axis part and/or the inner surface of the small-diameter cylinder part to supply these initial electrons. Also, at the same time, the potential gradient at the capacitive coupling part between the starting auxiliary conductor and the other electrode is increased to cause ionization, resulting in the generation of electrons and ions and the electrons also act as initial electrons.

Then, because the amount of the initial electrons to be supplied to the above capacitive coupling part is increased, giving rise to dielectric breakdown easily, which promotes and also ensures the starting of the discharge lamp.

A high-pressure discharge lamp lighting system according to a second invention is, as mentioned above, provided with a high-pressure discharge lamp and a lighting circuit that lights this high-pressure discharge lamp.

In the second invention, the aspect in which the high-pressure discharge lamp is connected to the lighting circuit is limited to a specific combination of a high-pressure discharge lamp and a lighting circuit, thereby improving the startability of the high-pressure discharge lamp freed of mercury. Specifically, the electrode to which the starting auxiliary conductor is connected is connected to a stable potential side output terminal among a pair of output terminals of the lighting circuit, and the electrode which is disposed facing the starting auxiliary conductor and is apart from the starting auxiliary conductor through the translucent sealed container is connected to an unstable potential side.

In the second invention, the high-pressure discharge lamp is free from mercury and xenon (Xe) having a pressure of one or more atm at ambient temperature of 25° C. and the metal halide are sealed as the ionization medium in the high-pressure discharge lamp. In the mercury-free high-pressure discharge lamp, dielectric breakdown at the start of lighting is carried on by creeping discharge along the inner surface of the translucent sealed container. The inventors of the present invention have discovered that strong creeping discharge is caused because the discharge lamp has the aforementioned aspect as the connection with the lighting circuit. The development of strong creeping discharge allows easy starting, resulting in low starting voltage. In this case, the strong creeping discharge means creeping discharge having large discharge energy. When the discharge energy of the creeping discharge is large, the creeping discharge is correspondingly made to be thick. This can be visually confirmed by using a high-speed moving picture camera.

The seal pressure of xenon is preferably 1 to 5 atm at ambient temperature of 25° C. If the seal pressure is in this range, the lamp can be started at a voltage of 5 kV or less from the above reason and therefore, a mercury-free high-pressure discharge lamp which is equipped with an E-type cap and used for general illumination can be obtained.

In the second invention, the high-pressure discharge lamp is preferably a mercury-free high-pressure discharge lamp in which xenon is sealed at a pressure of 1 to 5 atm, the metal halide contains at least one of thulium (Tm) and holmium (Ho) and which is provided with the starting auxiliary conductor and, according to the need, with a known starting auxiliary means such as a ultraviolet radiation discharge tube. Also, in order to obtain a more practical lamp voltage, a halide of a metal such as zinc (Zn) which is reduced in visible light emission and has a high vapor pressure is preferably added in a proper amount as the lamp voltage forming metal halide. Even in such a case, the amount of the lamp voltage-forming metal halide to be sealed in the high-pressure discharge lamp containing a halide of the above rare earth metals may be small and therefore, no disorder is caused by the halides.

In the second invention, there is no particular limitation to the circuit structure of the lighting circuit insofar as it can light the high-pressure discharge lamp. For example, known lighting circuits such as an AC lighting circuit using a full-bridge type inverter circuit and a DC lighting circuit using a DC chopper circuit may be used. However, in any circuit structure, the lighting circuit is so structured that one of the pair of output terminals has a relatively stable potential with respect to the other and the other has an unstable potential. In this case, the stable potential is not necessarily grounded but is only required to be relatively stable. Also, the lighting circuit may have a structure in which a pulse voltage generating circuit such as an igniter is added to apply a high-voltage pulse between the pair of electrodes of the high-pressure discharge lamp at the start of lighting.

In the second invention, strong creeping discharge is developed along the part facing the proximity conductor on the inner surface of the translucent sealed container at the start of lighting, with the result that the startability of the high-pressure discharge lamp is improved, though this reason has not been clarified.

A high-pressure discharge lamp lighting system according to a third invention is, as mentioned above, provided with a high-pressure discharge lamp, a lighting circuit that lights this high-pressure discharge lamp and a pulse voltage generating circuit. According to the third invention, the polarities of AC voltage and pulse voltage generated at the start of lighting are made to have specified relation to thereby improve the startability of the mercury-free high-pressure discharge lamp.

In the third invention, no particular limitation is imposed on the means that applies the AC voltage of the lighting circuit and the pulse voltage having a polarity opposite to that of the AC voltage to the high-pressure discharge lamp at the start of lighting. For example, the pulse voltage generating circuit is so structured as to generate pulse voltage synchronized with AC voltage as AC voltage of specified phase by energizing by the AC voltage of the lighting circuit to output the pulse voltage to the primary winding of a pulse trans and the secondary winding of the pulse trans of the pulse voltage generating circuit is interposed between the output terminal of the lighting circuit and the high-pressure discharge lamp. Then, the primary winding is connected to this secondary winding such that the primary winding is opposite in polarity to the secondary winding, thereby enabling the generated pulse voltage to be opposite in polarity to the AC voltage to superimpose the pulse voltage. As a result, the AC voltage upon which the pulse voltage opposite in polarity to the AC voltage is superimposed is applied to the high-pressure discharge lamp.

In the third invention, it is unnecessary for the pulse voltage generating circuit to continue its action once the high-pressure discharge lamp starts and it is preferable to stop the pulse voltage generating circuit. For example, as is known, the input terminal of the pulse voltage generating circuit is connected to the position on the circuit fluctuated corresponding to the voltage across the pair of electrodes of the high-pressure discharge lamp. If the high-pressure discharge lamp starts, the voltage across the pair of electrodes drops to the lamp voltage and therefore, it is preferably so designed in advance that the pulse voltage generating circuit never works at the dropped voltage.

When a pulse voltage having the polarity that makes the proximity conductor positive in polarity at the start of lighting is applied, in the third invention, electrons are generated in the translucent sealed container by the pulse voltage and these electrons are charged in the inner surface in the vicinity of the proximity conductor. When the pulse voltage is suspended, the electric field produced by the AC voltage and the electric field produced by the charged electrons are combined to produce a high electric field between the proximity conductor and a second electrode that is disposed opposite to and apart from the proximity conductor through the wall surface of the translucent sealed container, making easy the transfer to the primary discharge between the pair of electrodes, thereby improving the startability because AC voltage having a negative polarity is applied to the proximity conductor.

The third invention may adopt the aspects of the second invention which are applicable to the present invention. Also, in the third invention, the structures of the second invention may be combined and practiced according to the need. As a result, the effects of these inventions are produced in combination with each other, which more improves the startability.

A fifth aspect in the present invention relates to a high-pressure discharge lamp which is provided with the above sealed container, pair of electrodes and ionization medium, wherein the starting gas of the ionization medium contains mainly xenon at 1 to 10 atm at 25° C., and when the seal pressure of xenon is P (atm) and the inter-electrode distance is G (mm), the product PG satisfies the equation, 3≦PG≦60 and the dielectric breakdown voltage in the translucent ceramics sealed container is 5 kV or less.

In the fifth aspect of the present invention, the translucent ceramics sealed container has the structure in which the main part from which visible light generated by discharge and having a desired wavelength range can be extracted externally is made of translucent ceramics, ensuring that the coldest part temperature can be designed to be high. Along with this, the lamp voltage is made higher and therefore, the luminous efficacy of the high-pressure discharge lamp can be improved. The material of the translucent ceramics sealed container is the same as that mentioned in the first invention.

In the fifth aspect of the present invention, the pair of electrodes are used in the following manner. Specifically, this structure constitutes a high-pressure discharge lamp having such a system in which the electrode type discharge is induced by the pair of electrodes which are sealed and inserted into the translucent ceramics sealed container and disposed facing and apart from each other in a discharge space. The inter-electrode distance between the ends of the pair of electrodes allows general lighting lamps to seal metal halides, such as ZnI₂, having an ionization energy of 8 eV or more and a melting point of 500° C. or less as the metal halide that forms lamp voltage. However, this high-pressure discharge lamp is freed of mercury and therefore, the lamp voltage is not so much higher than in the case of using mercury. Therefore, it is preferable to design the inter-electrode distance to be relatively longer as will be mentioned below with the intention of obtaining practicable lamp voltage.

Specifically, the inter-electrode distance is 6 to 32 mm in the case of 100 W-class lamp power and 4 to 22 mm in the case of 35 W-class lamp power.

In the fifth aspect of the present invention, the dielectric breakdown voltage can be reduced to 5 kV or less and desired luminescent characteristics can be obtained by combining the inter-electrode distance (mm) and the seal pressure (atm) of the starting gas which will be described later such that the product of the both satisfies the specified equation. Also, a desired higher lamp voltage can be obtained by designing the inter-electrode distance to be 6 to 32 mm in the case of 100 W-class lamp power and 4 to 22 mm in the case of 35 W-class lamp power. As a result of the rise of lamp voltage, the ratio of a lamp current to a desired lamp power can be reduced that much and this leads to a reduction in electrode loss and hence to high luminous efficacy corresponding to the reduction in electrode loss.

Next, the ionization medium in the fifth aspect of the present invention will be explained. In the present invention, the ionization medium contains the metal halide and the starting gas.

First, the starting gas will be explained. Specifically, the starting gas is a rare gas primarily containing xenon at a pressure of 1 to 10 atm at 25° C. In this case, the seal pressure of the starting gas is preferably 2 to 6 atm. The description “primarily containing xenon” means that the volume of xenon is 80% or more. Examples of the rare gas miscible with xenon include argon (Ar), krypton (Kr) and neon (Ne).

Also, in the fifth aspect of the present invention, the seal pressure of the starting gas is 1 to 10 atm at 25° C. However, the seal pressure is designed to be a given value selected from the above range of seal pressure in correlation with the inter-electrode distance as will be mentioned later. When the seal pressure is less than 1 atm, the lamp voltage and luminous efficacy are reduced too much. Then, this requires a too much level of an improvement of the lamp voltage in the metal halide and lamp structure including an increase in the inter-electrode distance G and therefore makes practical designing difficult. When the seal pressure exceeds 10 atm on the other hand, the starting voltage is too high and it is therefore difficult to design the starting voltage to be 5 kV or less. In this case, the seal pressure of the starting gas is preferably 2 to 6 atm.

Next, the metal halide mentioned above will be explained. In the present invention, no particular limitation is imposed on the structure of the metal halide. However, the metal halide which contains at least a halide of a metal that primarily contributes to light emission and in addition, preferably has an ionization energy of 8 eV or more and a melting point of 500° C. or less is sealed as the lamp voltage forming metal halide.

In the fifth aspect of the present invention, the halide of a metal that primarily contributes to light emission is not particularly limited in the type and sealing amount. Preferably, the metal halide includes a halide of a rare earth metal that primarily contributes to light emission. Particularly, an aspect containing a halide of at least one of thulium (Tm) and holmium (Ho) brings about a desirable effect. Thulium (Tm) radiates many bright line spectrums in the vicinity of the peak wavelength of the luminosity characteristic curve and its peak of emitted light coincides with the peak of the luminosity characteristic curve. Therefore, thulium is a luminescent metal which is very effective to improve the luminous efficacy in the present invention. Also, thulium works to raise lamp voltage in a mercury-free state and can therefore reduce the sealing amount of the metal halides that primarily contribute to lamp voltage-formation. As a result, defects (increase in chromatic deviation) caused by relative excess sealing of the lamp voltage-forming metal halide can be avoided. It is to be noted that holmium also has a nature similar to that of thulium.

Also, the aspect in which a halide of thulium (Tm) and holmium (Ho) is sealed as the metal halide that primarily contributes to light emission is as follows. Specifically, the total amount of these metal halides is preferably 35% by mass or more of the total amount of the halides of metals that primarily contribute to light emission and is obtained by excluding the halides of metals that primarily contribute to lamp voltage-formation which will be described later. When the amount of the metal halide that primarily contributes to light emission is in this range, thulium (Tm) and holmium (Ho) develops the function of raising the lamp voltage to sufficiently practical range and also, a high luminous efficacy is obtained. For this, even if the sealing amount of the above metal halide such as ZnI₂ that is preferable for the lamp voltage formation is reduced to as small as, for example, ⅕, the same lamp voltage as that before the amount is reduced can be obtained. Moreover, if the above seal ratio is 50% by mass or more, a higher lamp voltage and a higher luminous efficacy can be obtained. When the above seal ratio exceeds 80% by mass, the seal ratio of halides of metals other than thulium (Tm) and holmium (Ho) is reduced correspondingly. As a result, a desired white light emission can not be obtained and the ratio exceeding 80% by mass is undesirable for the purpose of obtaining white light emission.

As the halogen forming the halide, iodine is preferable because it has adequate reactivity. However, the halogen may be bromine or chlorine as desired and desired two or more of iodine, bromine and chlorine may be used.

Halides of metals other than the above metals may be added optionally and selectively for the purpose of, for example, adjusting the luminescent chromaticity or improving the luminous efficacy. Typical examples of the case of adding halides of other metals will be explained.

If the amount of alkali metals such as sodium (Na) is designed to be 30% by mass or less based on the total amount of the halides of metals that primarily emit light, the lamp voltage can be kept at a higher level. Also, if the amount of these alkali metals is designed to be 25% by mass or less, the following results are obtained in an aspect sealing at least one of thulium and holmium as the metal that primarily emits light. Specifically, the luminosity of the alkali metals is weakened and the ratio of the luminosity of the above rare earth metals is increased on the contrary, bringing about an increase in average color rendering index Ra.

Moreover, the alkali metals are sealed in an amount less than 3% by mass when various conditions such as luminescent characteristics and productivity are allowed. This not only limits the reduction in lamp voltage to the minimum, but also can improve the luminous efficacy, lamp life, light color adjustment and particularly, chromatic deviation. From this point of view, these alkali metals may be sealed to the extent that a desired lamp voltage can be secured. The amount of these alkali metals is preferably 2 to 8% by mass, more preferably 3 to 7% by mass and even more preferably 4 to 6% by mass. As the other alkali metals, one or plural types among the group consisting of cesium (Cs) and lithium (Li) may be selectively sealed.

With regard to the halide of rare earth metals, halides of one or more types of other rare earth metals such as praseodymium (Pr), cerium (Ce) and samarium (Sm) may be sealed as sub-components in the aspect in which at least one of thulium (Tm) and holmium (Ho) is used as the metal that primarily emits light and its halide is sealed. The above rare earth metals are useful as luminescent metals next to thulium halide and holmium halide and may be sealed in a seal ratio of the prescribed amount or less. Specifically, all of the above rare earth metals radiate many bright line spectrums in the vicinity of the peak wavelength of the luminosity characteristic curve and are therefore able to contribute to an improvement in luminous efficacy.

An indium (In) halide may be selectively sealed as a sub-component with the intention of obtaining desired color rendering properties and/or color temperature.

Next, the metal halide for lamp voltage formation will be explained.

In the fifth aspect of the present invention, the metal halide for lamp voltage formation may be sealed in the translucent ceramics sealed container according to the need. As the metal halide for lamp voltage formation, many metal halides having an ionization energy of 8 eV or more and a melting point of 500° C. or less are included. Examples of these metal halides having an ionization energy of 8 eV or more and a melting point of 500° C. or less include halides of zinc (Zn), aluminum (AL) and manganese (Mn).

However, in the case of the aspect in which at least one of thulium halide and holmium halide is sealed in a specified ratio and rare gas primarily containing xenon at a pressure of 2 to 6 atm is sealed, a desired lamp voltage is formed, and therefore, it is unnecessary to seal the halide for forming lamp voltage. However, in the present invention, no particular limitation is imposed on the type and amount of the halide to be sealed and therefore, the lamp voltage-forming metal halide may be sealed in a prescribed amount if it is necessary to form a potential gradient of 7 V/mm or more between the pair of electrodes. In this case, the lamp voltage-forming metal halide may be sealed in an amount range from 0.3 to 1.6 mg/cc based on the internal volume of the translucent ceramics sealed container.

Also, the lamp voltage-forming metal halide has a higher vapor pressure than the above halide to be sealed in the translucent ceramics sealed container in the present invention, and has the function of primarily determining the lamp voltage in the high-pressure discharge lamp. The description “higher vapor pressure” means that the vapor pressure during lighting is higher, and is unnecessarily too large unlike mercury. The pressure of the lamp voltage-forming metal halide in the translucent ceramics sealed container during lighting is preferably about 5 atm or less. Therefore, if the above requirements are satisfied, the metal halide is not limited to specified metal halides.

Moreover, the lamp voltage-forming metal halide is constituted of metal halides primarily forming lamp voltage. As the metal halide for primarily forming lamp voltage, one or plural types of metal halides selected from the group consisting of magnesium (Mg), iron (Fe), cobalt (Co), chromium (Cr), zinc (Zn), nickel (Ni), manganese (Mn), aluminum (Al), antimony (Sb), beryllium (Be), rhenium (Re), gallium (Ga), titanium (Ti), zirconium (Zr) and hafnium (Hf) may be primarily used. Almost of these metal halides each have a lower vapor pressure than mercury and have a narrower control range of lamp voltage than mercury. However, the control range of lamp voltage can be widened by mixing and sealing plural halides according to the need.

Moreover, the lamp voltage-forming halides are halides of metals having many more difficulties in emitting visible light than metals of the above halides to be sealed in the translucent sealed container. The descriptions “many more difficulties in emitting visible light than metals of the above halides” means that visible light emission is smaller not in terms of absolute meaning but in terms of relative meaning. This reason is that though Fe and Ni surely emit much more light in the UV region than in the visible region, titanium, aluminum, zinc and the like emit much more light in the visible region. Therefore, if metals which emit much more light in the visible region is made to emit light independently, light emission in the visible region is increased because energy is concentrated on the metal. Though iron and nickel (Ni) among halides for lamp voltage formation emit much more light in the UV region, titanium, aluminum, zinc and the like emit much more light in the visible region when they are made to emit light independently. However, as to the metals, such as titanium, aluminum and zinc of the above lamp voltage-forming halides, the energy level required for each of these metals to emit light is higher than that required for each of the halides to emit light including thulium that primarily contributes to light emission. For this, in the case of sealing the both together to light the high-pressure discharge lamp, the light emission of the halides for light emission which metal has a low energy level is relatively predominant and hence the light emission of the lamp voltage-forming halides is small.

Therefore, the visible light emission of the latter halides is not prohibited and has a small influence because the proportion of this visible light to all visible light radiated from the discharge lamp is small. However, it has been clarified by the experiments conducted by the inventors of the present invention that a high-pressure discharge lamp using both of the halides simultaneously in a mixed state has a drawback to lamp characteristics as described later.

Next, the relation between the starting gas and the inter-electrode distance will be explained. The starting gas is sealed in the translucent ceramics sealed container such that, when the seal pressure of the starting gas is P (atm) at ambient temperature and the above inter-electrode distance is G (mm), the product PG satisfies the equation, 3≦PG≦60. When the value of the product PG is in the above range, the starting voltage is made to be 5 kV or less and the lamp voltage is made higher to keep a high luminous efficacy. When the product PG is less than 3 on the contrary, the lamp voltage is dropped, which is accompanied by reduced luminous efficacy. Therefore, a product PG out of the above range is undesirable. Also, when the product PG exceeds 60, this is undesirable because the dielectric breakdown voltage is raised and it is therefore difficult to maintain the starting voltage and momentary restarting voltage at 5 kV or less. The product PG preferably satisfies the equation, 10≦PG≦50 and more preferably satisfies the equation, 15≦PG≦30. Also, the product PG preferably satisfies the equation, 15≦PG≦60 in the case of 30 W-class lamp power and the equation, 15≦PG≦30 mm in the case of 100 W-class lamp power.

Other structures in the present invention will be explained below. These structures are not essential in the present invention. Therefore, they are structures that may be selectively and optionally adopted according to the need.

### 1. External Tube

The external tube is a means that receives at least the luminescent tube and the starting auxiliary means which will be explained later. Although the external tube may be designed to have any desired form and dimension, it may have the same form and dimension as a mercury-containing high-pressure discharge lamp for general illumination to make it easy to interchange with it. Also, the inside of the eternal tube is made air-tight with respect to outside and kept under vacuum or reduced pressure, the coldest part temperature of the luminescent tube can be raised to improve the luminous efficacy. However, in the case where the material of the luminescent tube is quartz glass according to the need, the external tube may be communicated with the open air. When the external tube is air-tightly sealed from the open air, inert gas such as argon or nitrogen may be sealed instead of the open air according to the need. Moreover, the external tube may be formed using a translucent material such as quartz glass, hard glass or soft glass. It is to be noted that the term “luminescent tube” is an expression used with respect to the external tube for the sake of convenience, and in the present invention, the luminescent tube is an assembly including the translucent ceramics sealed container, the pair of electrodes and the ionization medium.

### 2. Starting Auxiliary Material

The starting auxiliary material is a means that is usually disposed in the external tube and aids the start-up so as to easily initiate a discharge in the luminescent tube when applying a starting high voltage of 5 kV or less across the pair of electrodes disposed in the translucent ceramics sealed container. Though there is no particular limitation to the specific structure of the starting auxiliary means in the present invention, at least one of, for example, the proximity conductor and ultraviolet enhancer may be used as the starting auxiliary means. Also, other known starting auxiliary materials such as a starter may be used as desired.

Then, when a starting high voltage of 5 kV or less is applied across the pair of electrodes in the luminescent tube at the start of lighting, the proximity conductor forms a large potential gradient in a short space between its tip and the other electrode facing the tip. As a result, the starting of the high-pressure discharge lamp is promoted because the dielectric breakdown of the discharge lamp is easily caused when the starting high voltage is applied. When the high-pressure discharge lamp starts, the glow discharge generated in the luminescent tube is further transferred to arc discharge to short the proximity conductor and therefore, there is no hindrance to lighting.

As the ultraviolet enhancer, any ultraviolet enhancer may be used insofar as it is connected in parallel to the luminescent tube and disposed in the vicinity of at least one electrode of the luminescent tube to radiate ultraviolet rays in the vicinity of the adjacent electrode at the start of high-pressure discharge lamp, without any inquiry into other structures. Then, the ultraviolet enhancer is provided with an ultraviolet transmittable external enclosed container, the ionization medium sealed in the external enclosed container and a pair of electrodes that cause the dielectric-barrier discharge or glow discharge of the ionization medium. In this case, it is preferable to allow the ionization medium to contain mercury or nitrogen such that the ultraviolet enhancer radiates long-wavelength ultraviolet rays transmitting through the translucent ceramics sealed container of the high-pressure discharge lamp. In the case of using mercury, mercury is added to rare gas. Also, in the case of nitrogen, 100% of nitrogen is sealed or nitrogen and rare gas are sealed in an appropriate ratio.

Then, the ultraviolet enhancer works to radiate ultraviolet rays at the start of the high-pressure discharge lamp and then the ultraviolet rays are irradiated to the luminescent tube or the vicinity of one electrode. As a result, electrons are emitted from the inner surface of the translucent ceramics sealed container or from the electrodes by the photoelectric effect obtained by the ultraviolet irradiation and these initial electrons are supplied to excite the ionization medium, thereby promoting the initiation of the lighting of the high-pressure discharge lamp. When the high-pressure discharge lamp is started, the ultraviolet enhancer is shorted by the arc generated in the luminescent tube and there is no hindrance to lighting.

The starter has a structure provided with a switching means such as a glow starter, bimetal switch or nonlinear capacitor and is disposed in the external tube. The starter carries on a rapid switching action when turning on the power to apply the starting high voltage generated in the stabilizer across the electrodes of the luminescent tube, thereby make it easy to initiate the high-pressure discharge lamp.

### 3. Starting High Voltage

The high-pressure discharge lamp of the present invention can be started by applying a starting high voltage of 5 kV or less. However, no particular limitation is imposed on the aspects taken to apply the starting high voltage to the starting high-pressure discharge lamp. For example, the system of applying the starting high voltage to the high-pressure discharge lamp may have, any of an aspect in which a high-voltage pulse generated from a high-voltage pulse generator called the igniter or the so-called kick voltage generated from a stabilizer is applied to the luminescent tube from the outside of the high-pressure discharge lamp and an aspect in which the starting high voltage generated from a high-voltage generator disposed in the external tube or the cap is applied to the luminescent tube. For example, a thermally answering switch or voltage answering switch may be disposed in the external tube as desired to generate the kick voltage.

### 4. Rated Lamp Power and Applications of the High-Pressure Discharge Lamp

In the present invention, the rated lamp power of the high-pressure discharge lamp is preferably about 30 to 250 W, though it may be freely designed to have a value ranging widely. Also, as to the applications of the high-pressure discharge lamp, it is preferably used for general illuminations though it may be used in various applications. Therefore, a translucent ceramics sealed container having an adequate shape and dimensions, an inter-electrode distance having a proper value and an ionization medium having adequate value and proper sealing amount may be properly selected according to the rated lamp power and applications.

### 5. Relation Between the Load on the Tube Wall and the Temperature of the Translucent Ceramics Sealed Container

In the present invention, the load on the tube wall is preferably 15 to 35 W/cm² though no particular limitation is imposed on it. In this case, the load on the tube wall is a value obtained by dividing the lamp power by the internal area of the enclosed part surrounding the discharge space of the translucent ceramics sealed container.

### 6. Protective Means When the Luminescent Tube is Ruptured

A known protective means may be used for the protection from the scatter of splinters generated when the luminescent tube is ruptured. For example, a quartz glass cylinder called the “shroud” is disposed in the external tube so as to surround the luminescent tube primarily with the enclosed part of the translucent ceramics sealed container as its center. Also, the whole external tube may be surrounded further by a protective glass tube. Moreover, for example, the thickness of the glass may be increased and a string-like materials made of a reinforcing metal or inorganic fiber may be wound around the shroud as needed to fulfill the necessary explosion-proof characteristics when the luminescent tube is ruptured.

In the fourth invention, the lighting equipment means equipment using, as the light source, the high-pressure discharge lamp of the present invention and is a concept including lighting devices, marker lamps, pilot lamps, photochemical reactors and inspection devices. Also, the lighting equipment body means the remainder part excluding the high-pressure discharge lamp and its lighting device from the lighting equipment.

### DESCRIPTION OF THE PREFERRED EMBODIMENTS EXAMPLE

Embodiments of the present invention will be explained with reference to the drawings.

### First Embodiment

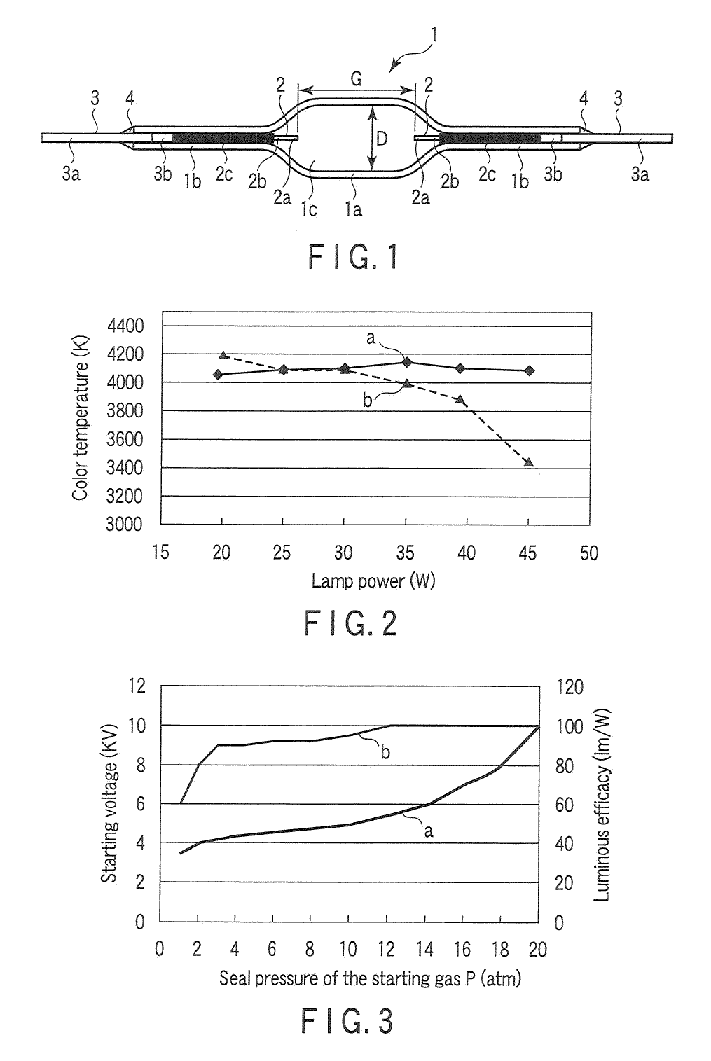

FIG. 1 is a sectional view of a luminescent tube showing an embodiment of a high-pressure discharge lamp according to the present invention. The high-pressure discharge lamp has a structure in which the luminescent tube is provided with a translucent ceramics sealed container 1, an electrode 2, a current introducing conductor 3, a seal 4 and an ionization medium.

The translucent ceramics sealed container 1 is made of translucent polycrystalline alumina ceramics. As the translucent polycrystalline alumina ceramics, one containing about 300 ppm of magnesium (MgO) as an additive may be used. Also, in the case of the translucent polycrystalline alumina ceramics primarily containing translucent ceramics, the coldest part temperature is designed to be high to thereby raise the lamp voltage and also to improve the luminous efficacy, and also, it is superior in resistance to corrosion caused by the ionization medium. The above sealed container 1 is provided with an enclosed part 1a and a pair of small-diameter cylinder parts 1b disposed in communication with both ends of enclosed parts 1a. Then, the small-diameter cylinder part 1b and the enclosed part 1a are integrated by casting molding. It is to be noted that the internal volume of the sealed container 1 is V (cc).

The enclosed part 1a has a swollen cocoon-shaped configuration including a cylinder middle part and a pair of hemisphere parts stretched to each end of the cylinder middle part. In the enclosed part 1a, a discharge space 1c having almost same shape as the enclosed part 1a is formed. The small-diameter cylinder part 1b has a narrow pipe shape. The small-diameter cylinder part 1b is extended outward as one body along the direction of the tube axis from each end of the enclosed part 1a in the direction of the tube axis. The tip of the small-diameter cylinder part 1b is communicated with the center part of the hemisphere part of the enclosed part 1a.

Electrodes 2 are provided with a pair of electrodes main parts 2a which are disposed so as to command the inside of the enclosed part 1a, and are formed of doped tungsten respectively provided with the electrode main part 2a, an electrode axis part 2b and an electrode axis coil 2c. The electrode main part 2a is the tip part of the electrode axis part 2b having a bar-like form as a whole. The electrode axis part 2b is penetrated through the center part of the small-diameter cylinder part 1b. The electrode axis coil 2c is formed by winding doped tungsten fine wire around the electrode axis part 2b.

Then, a capillary made of a slight clearance is formed between the electrode axis coil 2c wound around the electrode axis part 2b and the inner surface of the small-diameter cylinder part 1b. The interval between the tips of the electrode main parts 2a exposed to the inside of the enclosed part 1a of the pair of electrodes 2 is the inter-electrode distance G (mm).

The pair of current introducing conductors 3 are each made of a niobium bar-like material 3a and a molybdenum bar-like material 3b. The niobium bar-like material 3a has a structure in which its tip is inserted into the inside of the small-diameter cylinder part 1b and its base end is projected externally from the small-diameter cylinder part 1b. The molybdenum bar-like material 3b is bound with the tip of the niobium bar-like material 3a by butt welding inside of the small-diameter cylinder part 1b. The above bar-like material 3b is integrated with the base end of the electrode axis part 2a bound with its tip by butt welding to support the electrode 2.

A pair of seal parts 4 is formed by heating a ceramics seal compound made of Dy₂O₃—SiO₂—Al₂O₃, as a flit glass, to melt and then to solidify the melted compound. Each of the pair of seal parts 4 is interposed between the inner surface of the end surface side of each of the pair of small-diameter cylinder parts 1b of the translucent ceramics sealed container 1 and primarily the intermediate part and end part of the niobium bar-like material 3a and the base end part of the molybdenum bar-like material 3b of the current introducing conductor 3 opposing thereto. The seal parts 4 seal the translucent ceramics sealed container 1 air-tightly to provide the so-called current introducing conductor insertion seal structure. Also, the seal part 4 covers the entire of the part of the niobium bar-like material 3a of the current introducing conductor 3 which part is inserted into the small-diameter cylinder part 1b so as to prevent the niobium bar-like material 3a from being exposed to the inside of the translucent ceramics seal container 1. The electrode 2 is secured at the specified position of the translucent ceramics sealed container 1 by the above seal structure.

The ionization medium is made of starting gas including a halide that primarily emits light and a halide that primarily forms lamp voltage. The starting gas is rare gas at 1 to 20 atm at ambient temperature. Each of the above halides is sealed in excess of the amount to be vaporized and therefore, excess halides are retained in the capillary formed in the small-diameter cylinder parts 1b in a liquid phase at the time of stable lighting of the high-pressure discharge lamp. Then, the coldest part is formed in the vicinity of the surface layer part of the enclosed part 1a side of the ionization medium retained in a liquid phase in the capillary of, for example, the small-diameter cylinder part 1b which is located below during lighting.

The halide that primarily emits light is a halide of thulium (Tm) and sodium (Na). The halide that primarily forms lamp voltage is a halide of zinc (Zn).

### EXAMPLE

Specific example of the first invention will be explained with reference to FIG. 1.

Translucent ceramics sealed container: maximum inside diameter (D) 5.0 mm, Internal volume (V) 0.2 cc

Inter-electrode distance G: 9.0 mm

Ratio D/G: 0.9

Ionization medium:
Starting gas: Xe 3 atm
Halide: NaI—TmI₃—ZnI₂ (% by mass 24.4:73.2:2.4) 4.1 mg

Tube wall load: 20 W/cm²

Rated lamp power: 35 W

Lamp voltage: 50 V

Luminous efficacy: 90 lm/W

FIG. 2 is a graph showing the toning characteristics of the high-pressure discharge lamp of the present invention in contrast with that of a comparative example. In FIG. 2, the abscissa is lamp power (W) and the ordinate is color temperature (K).

In FIG. 2, the line a (present invention) is the result of a high-pressure discharge lamp whose specification is shown in the above example. Also, the line b (Comparative Example) is a high-pressure discharge lamp which has the same specification as the above Example except that the halide contains thallium and is represented by NaI—TmI₃—TlI—ZnI₂ (% by mass 22:66:3:9).

It is found from FIG. 2 that according to the present invention, almost no variation in luminescent color is caused by light toning.

FIG. 3 is a graph showing the relation between the seal pressure of the starting gas, starting voltage and luminous efficacy of the present invention. In FIG. 3, the abscissa is the seal pressure P (atm) of the starting gas and the ordinate is the starting voltage (kV) on the left and the luminous efficacy (lm/W) on the right. In FIG. 3, the line a shows the starting voltage as a function of the seal pressure P of the starting gas and the line b shows the luminous efficacy as a function of the seal pressure P of the starting gas.

It is found from FIG. 3 that according to the present invention, a starting voltage of 10 kV or less and a luminous efficacy of 60 lm/W or more are obtained when the seal pressure P of the starting gas is in a range of 1 to 20 atm. However, a starting voltage of 7 kV or less and a luminous efficacy of 60 lm/W or more are obtained when the seal pressure P of the starting gas is in a range of 1 to 16 atm. Also, a starting voltage of 5 kV or less is obtained when the seal pressure P of the starting gas is in a range of 1 to 5 atm, and a luminous efficacy of 90 lm/W or more is obtained when the seal pressure P of the starting gas is in a range of 3 to 8 atm.

### Second Embodiment

An embodiment of the present invention will be explained with reference to the drawings.

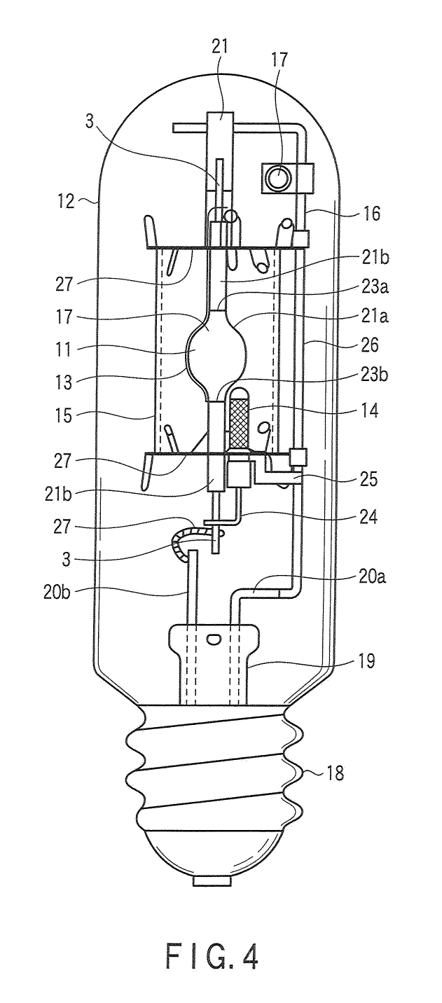

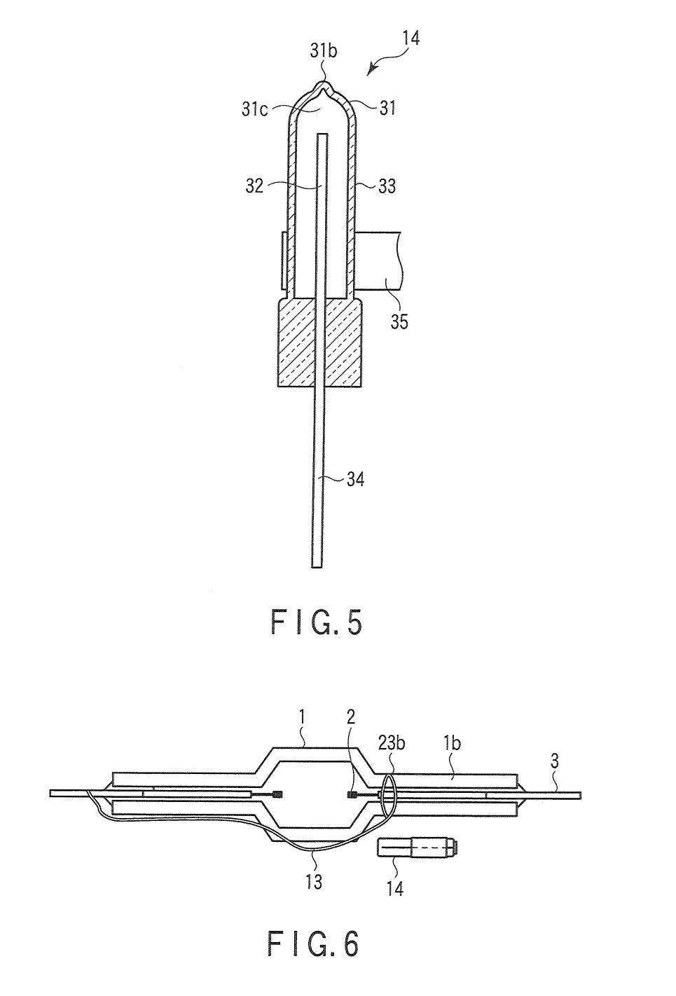

FIGS. 4 to 7 show an embodiment of a ultraviolet enhancer according to the present invention. FIG. 4 is a sectional view of the whole of the high-pressure discharge lamp. FIG. 5 is a sectional view of the ultraviolet enhancer. FIG. 6 is a sectional view schematically showing the positional relation between the luminescent tube and the ultraviolet enhancer. As to the luminescent tube, the same members as those in FIG. 1 are designated by the same reference numerals and explanations of these members are not repeated here.

The high-pressure discharge lamp in this embodiment as shown in FIG. 4 is a metal halide lamp having a rated lamp power of 100 W-class which can be adapted to general illumination applications. The high-pressure discharge lamp is provided with a luminescent tube 11, an external tube 12, a starting auxiliary conductor 13, a ultraviolet enhancer 14, a protective glass tube 15, a luminescent tube support member 16 and a cap 18.

The luminescent tube 11, as shown in FIG. 1, includes a translucent sealed container 1, a pair of electrodes 2, a pair of current introducing conductors 3, a pair of seal materials 4 and an ionization medium.

The external tube 12 is made of hard glass. Then, the members such as the luminescent tube 11, starting auxiliary conductor 13, ultraviolet enhancer 14, protective glass tube 15, luminescent tube support member 16 and a getter 17 are received in each specified position in the external tube 12, the inside being kept under vacuum. Also, the external tube 12 is provided with a flare stem 19 by sealing it at the neck part positioned below in FIG. 4. The flare stem 19 is provided with a pair of internal lead wires 20a and 20b which are air-tightly projected to the inside of the external tube 12.

The luminescent tube 11 is disposed almost in the center of external tube 12 along the center axis in the external tube 12. The current introducing conductor 3 on the upper part of the luminescent tube 11 is welded to and supported by a connecting fragment 21 which will be described later and also, connected to an internal lead wire 20a through a luminescent tube support member 16. Also, the current introducing conductor 3 on the lower part of the luminescent 11 is welded to and supported by a connecting conductor 22 and also, connected to an internal lead wire 20b through the connecting conductor 22 as shown in FIG. 4.

One end of the starting auxiliary conductor 13 is welded to the current introducing conductor 3 on the upper part of the luminescent tube 11 as shown in FIG. 1. Then, the middle part of the starting auxiliary conductor 13 is wound around the translucent sealed container 1 in the vicinity of the boundary between the small-diameter cylinder part 1b on the upper part and the enclosed part 1a to form a first ring part 23a. The starting auxiliary conductor 13 is extended downward along the direction of the tube axis in such a manner as to be close to the outer periphery of the enclosed part 1a. Also, the other end of the starting auxiliary conductor 13 is wound around the small-diameter cylinder part 1b in the vicinity of the boundary between the small-diameter cylinder part 1b on the lower part and the enclosed part 1a to form a second ring part 23b. Then, as shown in FIG. 4, a capacitive coupling part (not shown) is formed between the second ring part 23b and the axis part of the electrode 2 which is disposed below the second ring parts 23b and penetrated through the inside of the small-diameter cylinder part 1b.

Therefore, starting high voltage is applied to the above capacitive coupling part because the potential of the second ring part 23b of the starting auxiliary conductor 13 is equal to the potential of an electrode (not shown) on the upper part of FIG. 4 at the start of lighting. Therefore, a large potential gradient arises at the small-diameter cylinder part 1b interposed between the second ring part 23b and the lower electrode. As a result, electrons (or ions) are retained as static charges on the inner surface of the small-diameter cylinder part 1b which acts as the dielectric of the capacitive coupling part. For this, when starting high voltage is applied across the pair of electrodes 2 of the luminescent tube 11, initial electrons are supplied to the inside of the luminescent tube 11 by the charge action of the starting auxiliary conductor 13 to thereby promote the starting of the high-pressure discharge lamp.

The ultraviolet enhancer 14 is provided with a ultraviolet transmittable external enclosed container 31, the ionization medium, an internal electrode 32 and an external electrode 33 as shown in FIG. 5.

The ultraviolet transmittable external enclosed container 31 is made of ultraviolet transmittable glass. Then, the ultraviolet transmittable external enclosed container 31 is formed with a seal part 31a at its base end and with an exhaust gas chip-off part 31b at its tip part and provided with an airtight discharge space 31c inside thereof. The seal part 31a is formed by a pinch seal.

The ionization medium contains nitrogen. The nitrogen is sealed in the discharge space 31c through an exhaust tube (not shown) which is joined in advance to the top of the ultraviolet transmittable external enclosed container 31 before the exhaust gas chip-off part 31b is formed in the discharge space 31c of the ultraviolet transmittable external enclosed container 31. Then, after the ionization medium containing nitrogen, or mercury and rare gas such as argon is sealed, the exhaust tube is fused and then, the fused part is closed. As a result, the above exhaust gas chip-off part 31b is formed.

The internal electrode 32 has a bar-like form or a plate-like form. The internal electrode 32 is disposed in such a manner that it is penetrated air-tightly through the seal part 31a of the ultraviolet transmittable external enclosed container 31 and extended along the center axis position in the discharge space 31c. In this case, a conductor 24 is led out of the seal part 31a. The external electrode 33 is disposed in close contact with the outer peripheral surface of the ultraviolet transmittable external enclosed container 31. Specifically, the external electrode 33 is made of a conductive metal mesh body. Then, the external electrode 33 surrounds the outer peripheral surface of the ultraviolet transmittable external enclosed container 31 and one end of a band-shaped conductor 25 is wound around the external electrode 33 to bring the external electrode 33 into close contact with the outer peripheral surface of the ultraviolet transmittable external enclosed part 31.

Then, in the ultraviolet enhancer 14, first, a prescribed voltage is applied across the internal electrode 32 and the external electrode 33, that is, the starting voltage is applied across the pair of electrodes 32 and 33 of the high-pressure discharge lamp which will be explained later. This induces dielectric barrier discharge of the ionization medium in the discharge space 31c of the ultraviolet transmittable external enclosed container 31 to emit ultraviolet rays. This ultraviolet rays include many ultraviolet rays having a long wavelength ranging from 300 to 400 nm because the ionization medium contains nitrogen or mercury. The emitted long-wavelength ultraviolet rays are primarily transmitted through the transmittable external enclosed container 31 and the mesh part of the external electrode 33 and extracted externally.

Also, the ultraviolet enhancer 14 is, as shown in FIG. 4, disposed close to the side of the capacitive coupling part formed between the other electrode positioned on the lower part of the luminescent tube 11 and the second ring part 23b of the starting auxiliary conductor 13. In this condition, the external electrode 33 is disposed almost in parallel to the part of the translucent ceramics sealed container 1 on the side of the joint part with the enclosed part 1a of the small-diameter cylinder part 1b and also disposed almost rightly opposite to the capacitive coupling part. Then, the conductor 24 led out of the internal electrode 32 is welded to the current introducing conductor 3 on the lower part of the luminescent tube 11 in FIG. 4. Also, the conductor 25 led out of the external electrode 33 is welded to a support frame 26 of the luminescent tube support member 16 which will be described later. Therefore, the ultraviolet enhancer 14 is connected in parallel to the luminescent tube 11.

When starting high voltage is applied across the internal electrode 32 and external electrode 33 of the ultraviolet enhancer 14 at the start of the high-pressure discharge lamp, dielectric barrier discharge is first induced to generate ultraviolet rays having a wavelength from 300 to 400 nm to irradiate the small-diameter cylinder part 2b on the center of the capacitive coupling part of the luminescent tube 11. The ultraviolet rays transmit the small-diameter cylinder part 1b of the translucent ceramics sealed container 1 to irradiate the lower electrode and the inner surface of the small-diameter cylinder part 1b. As a result, electrons are emitted from the capacitive coupling part and from the surface of the axis part of the electrode 2 positioned on the lower part of FIG. 4 in the vicinity of the capacitive coupling part and/or the inner surface of the small-diameter cylinder part 1b by the photoelectric effect.

Therefore, the electrons (or ions) generated by the charges from the starting auxiliary conductor 13 and the electrons supplied by photoelectric effect obtained by ultraviolet irradiation of the ultraviolet enhancer 14 are added in the inside of the small-diameter cylinder part 1b at the capacitive coupling part between the starting auxiliary conductor 13 and the lower electrode 2. As a result, a large quantity of initial electrons are supplied, and therefore, the high-pressure discharge lamp is easily started and surely promoted, resulting in improved startability of the high-pressure discharge lamp. In this case, as to the electrons emitted from the inner surface of the small-diameter cylinder part 1b, many electrons are emitted especially from magnesium oxide added to polycrystalline alumina ceramics constituting the translucent ceramics sealed container 1.

The protective glass tube 15 is made of a quartz glass cylinder body. The protective glass tube 15 encloses the periphery of the luminescent tube 11 at some distance to thereby limit the scatter of splinters generated when the luminescent tube 11 is ruptured. Then, the protective glass tube 15 is supported by the luminescent tube support member 16 as will be described later.

The luminescent tube support member 16 is constituted of the support frame 26, a pair of support plates 27 and the connecting fragment 21. The support frame 26 is obtained by bending a stainless steel bar into an elongated deformed U-shape and connected to the internal lead wire 26a. The pair of support plates 27 are obtained by forming stainless steel plate into an almost disk form and secured to the support frame 26. Also, the pair of support plates 27 are respectively formed with a through-hole in the center thereof. The pair of small-diameter cylinder parts 1b of the translucent sealed container 1 are respectively made to penetrate through the above through-hole to thereby station the luminescent tube 11 at the tube axis position of the external tube 12 and also, to support the luminescent tube 11 in the direction of the tube axis.

The connecting fragment 21 is welded to the upper part of the support frame 26 and connected to the current introducing conductor 3 on the upper part in FIG. 4. The pair of support plates 27 are engaged with the upper and lower end surfaces of the protective glass tube 15 respectively to hold the protective glass tube 15 between the both and also secured to the luminescent tube support member 16. Therefore, the protective glass tube 15 is supported by the luminescent tube support member 16 through the pair of support plates 27.

The getter 17 is a performance getter supported by the upper part of the luminescent tube support member 16 in FIG. 4. The cap 18 is a screw type cap, and is fitted to the lower part of the external tube 12 in FIG. 4 and connected to the pair of internal lead wires 20a and 20b.

According to the present invention, the starting auxiliary conductor 13 capacitively coupled to the electrode 2 through the small-diameter cylinder part 1b of which one end is electrically connected to one of the electrodes 2 of the luminescent tube 11 and the other end is facing the other electrode 2 of the luminescent tube 11 and the ultraviolet enhancer 14 disposed close to the side of the capacitive coupling part between the other electrode 2 of the luminescent tube 11 and the starting auxiliary conductor 13 are provided. When starting high voltage is applied between the pair of electrodes 2 of the ultraviolet enhancer 14, the ultraviolet rays generated from the ultraviolet enhancer are efficiently irradiated to the above capacitive coupling part from the outside, thereby supplying initial electrons to the inside of the small-diameter cylinder part 1 in the capacitive coupling part by photoelectric effect. Also, at the same time, the inner surface of the small-diameter cylinder part interposed as a dielectric at the capacitive coupling part between the starting auxiliary conductor 13 and the other electrode 2 of the luminescent tube 11 charges when the starting high voltage is applied, initial electrons are supplied from the inner surface of the small-diameter cylinder part at the capacitive coupling part. The above initial electrons are supplied simultaneously from both parts so that the initial electrons are increased, with the result that dielectric breakdown takes place at the capacitive coupling part, which triggers the starting of the high-pressure discharge lamp to develop the discharge across the pair of electrodes 2 of the luminescent tube 11. Therefore, the present invention makes it possible to start the high-pressure discharge lamp at a relatively low starting voltage and can therefore provide a high-pressure discharge lamp improved in startability and lighting equipment provided with this high-pressure discharge lamp.

### Third Embodiment

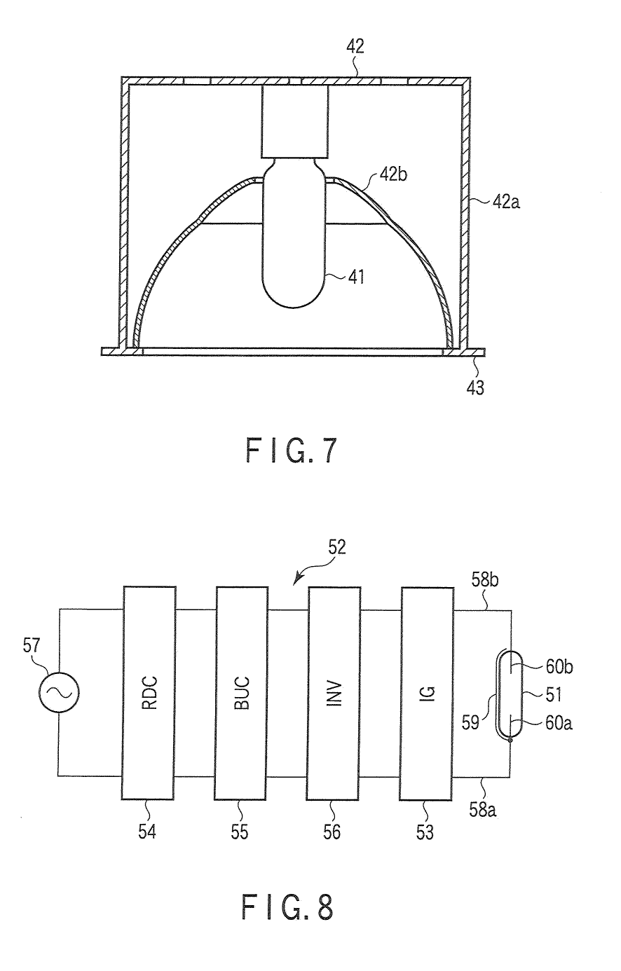

FIG. 7 is a sectional view showing a recessed type ceiling down light in an embodiment of lighting equipment according to the present invention.

In FIG. 7, the reference numeral 41 denotes a high-pressure discharge lamp, and the reference numeral 42 denotes-a lighting fitting body. The high-pressure discharge lamp 41 has the structure of the high-pressure discharge lamp of the present invention as shown in FIG. 1. The lighting fitting body 42 constitutes a recessed type ceiling down light and is provided with a base body 42a and a reflecting plate 42b. The base body 42a is provided with a ceiling contact edge 43 at its lower end, so that it is embedded in the ceiling. The reflecting plate 42b is supported by the base body 42a and encloses the lighting fitting body in such a manner that the emission center of the high-pressure discharge lamp 41 is positioned almost at its focal point.

The high-pressure discharge lamp lighting device (illustration is omitted) that lights the high-pressure discharge lamp 41 may be disposed in the lighting fitting body 42 or may be separately disposed either at a position adjacent to or remote from the lighting fitting body 42.

### Fourth Embodiment

A high-pressure discharge lamp lighting system according to the present invention will be explained with reference to FIG. 1, FIG. 4 and FIG. 8. FIG. 1 and FIG. 4 are already described and therefore the same members are designated by the same reference numerals and explanations of these members are not repeated here.

The high-pressure discharge lamp lighting system is, as shown in FIG. 8, provided with a high-pressure discharge lamp 51, a lighting circuit 52 and a pulse generating circuit (IG) 53. The lighting circuit 52 is provided with a rectifying DC power source (RDC) 54, a boosting chopper circuit (BUC) 55 and an inverter circuit (INV) 56, and energized by an AC power source 57.

First, the high-pressure discharge lamp 51 will be explained. The high-pressure discharge lamp 51 is a rated lamp power 100 W-class as mentioned above and is provided with a luminescent tube 11, an external tube 12, a proximity conductor 13, ultraviolet radiation discharge tube 14, a protective glass tube 15, a luminescent tube support member 16, a getter 17 and a cap 18.

When the sealed container 1 is made of quartz glass, quartz glass of the seal end 1b is softened by heating to seal using a known seal means such as pinch seal. In the case of using the translucent ceramics in the same manner as in this embodiment, for example, a flit sealing means of pouring flit glass in a space between the translucent ceramics and the introduction conductor 3 to seal is used. Also, various seal means such as metal sealing using a metal instead of flit glass and a means of melting an opening of the sealed container 1 which is intended to be sealed, to seal the current introducing conductor 3 directly or indirectly may be optionally and selectively adopted. Also, the small-diameter cylinder part 1b communicated with the enclosed part 1a may be designed to have a prescribed relatively large length to keep the coldest part of the discharge space at a desired relatively high temperature while maintaining the seal part at a desired relatively low temperature.

The inter-electrode distance to be formed between the tips of the pair of electrodes is preferably designed to be relatively large in the following manner for the purpose of obtaining practicable lamp voltage in case of the general lighting lamps. This reason is that though a metal halide such as ZnI₂ having an ionization energy of 8 eV or more and a melting point of 500° C. or less is sealed as the metal halide for forming lamp voltage, the lamp voltage is not higher unlike the case of using mercury because the high-pressure discharge lamp is free from mercury.

Specifically, the inter-electrode distance is 16 to 38 mm in the case of 100 W-class lamp power and 9 to 22 mm in the case of 35 W-class lamp power, for example. Also, when the above metal halide for forming lamp voltage such as ZnI₂ is sealed in an amount of 0.3 to 1.6 mg/cc based on the internal volume of the sealed container and the inter-electrode distance is designed to be 14 to 32 mm in the case of 100 W-class lamp power and 7 to 18 mm in the case of 35 W-class lamp power, a desired higher lamp voltage can be obtained. If, in addition to this inter-electrode distance, the maximum inside diameter of the translucent ceramics sealed container is designed to be 4 to 7 mm in the case of 100 W-class lamp power and 3 to 5 mm in the case of 35 W-class lamp power, the coldest part temperature of the luminescent tube can be kept high, making it possible to maintain a high luminous efficacy.

Also, the current introducing conductor 3 is constituted of a series connector consisting of a seal part 3a and an anti-flammable part 3b in this embodiment. The seal part 3a is air-tightly bonded directly or indirectly to the ceramics of the small-diameter cylinder part 1b to seal the translucent sealed container 1 and is, therefore, made of a conductive material having better bonding ability. On the other hand, the anti-flammable part 3b supports the electrode 2 and is interposed between the electrode 2 and the seal part 3a to moderate a difference in thermal expansion between the both.

Also, the seal part 3a may be constituted using either a seal metal or thermet. As the seal metal, conductive metals having a similar coefficient of thermal expansion of the translucent ceramics constituting the small-diameter cylinder part 1b of the translucent sealed container 1 may be used. Examples of these conductive metals include niobium (Nb), tantalum (Ta), titanium (Ti), zirconium (Zr), hafnium (Hf), vanadium (V), platinum (Pt), molybdenum (Mo) and tungsten (W). As the thermet, a sintered body of a mixture of the above metal and ceramics may be adopted.

Also, when aluminum oxide such as translucent polycrystalline alumina ceramics is used as the material of the sealed container 1, this is preferable for sealing because niobium and tantalum have almost the same average coefficient of thermal expansion as aluminum oxide and also, molybdenum has the average coefficient of thermal expansion close to that of the above oxide. Yttrium oxide and YAG also have a small difference in average coefficient of thermal expansion. When aluminum nitride is used for the translucent ceramics sealed container, zirconium is preferably used as the current introducing conductor.

Moreover, the seal part 3a may be formed by joining plural material parts. For example, the seal part 3a may have a structure in which a part is made of a metal selected from the above group and a thermet is joined with the metal part in the direction of the tube axis or in a peripheral direction perpendicular to the tube axis. Then, in the case of using a thermet as at least a part of the seal part 3a of the current introducing conductor 3, the small-diameter cylinder part 1b of the translucent sealed container 1 and the current introducing conductor 3 is air-tightly bonded at the position of the thermet or at the position which is extended over both the thermet and the seal metal to form the seal part of the translucent sealed container 1.

As the above thermet, for example, the ceramics of the material component is alumina ceramics and the metal is one or plural types of conductive metals selected from the above groups, for example, molybdenum (Mo), tungsten (W) or niobium (Nb). Also, the thermet at the part where the current introducing conductor is bonded to the translucent ceramics sealed container may contain at least a conductive metal component such as niobium (Nb), molybdenum (Mo) and tungsten (W) and a ceramics component such as alumina, YAG and yttria wherein the content ratio of the metal component may be 5 to 60% by mass.

The electrode axis coil 2c is formed by winding doped tungsten fine wire around the outer peripheral surfaces of the electrode axis part 2a and the anti-flammable part 2b of the current introducing conductor 3 in the small-diameter cylinder part 1b as shown in FIG. 1. Therefore, a small clearance is formed between the outer peripheral surface of the electrode axis coil 2c and the inner surface of the small-diameter cylinder part 1b.

The seal part 4 serves to seal the translucent sealed container 1 by air-tightly bonding the seal part 3a of the current introducing conductor 3 to the small-diameter cylinder part 1b. In the present invention, flit glass may be used to carry out the above bonding or the seal part 3a of the current introducing conductor 3 may be directly fusion-bonded to the small-diameter cylinder part 1b.

In this embodiment, the seal part 4 is made of a melt and solidified body of flit glass, that is, a ceramics compound, which penetrates into the small-diameter cylinder part 1b in a molten state and is then air-tightly filled in a clearance between the seal part 3a of the current introducing conductor 3 positioned in the small-diameter cylinder part 1b and the inner surface of the small-diameter cylinder part 1b, and also surrounds the seal part 3a so as to prevent the surface of the seal part 3a from being exposed to the inside of the translucent sealed container 1.

The ionization medium is sealed in the translucent sealed container 1 and contains a metal halide and xenon at a pressure of 1 atm or more at 25° C. but no mercury. In the present invention, no particular limitation is imposed on the metal halide. However, the ionization medium preferably contains at least one of thulium (Tm) and holmium (Ho) as the metal halide and xenon at a seal pressure of 1 to 5 atm at 25° C. It is more preferable that a metal halide having an ionization energy of 8 eV or more and a melting point of 500° C. or less be contained as the metal halide for forming lamp voltage.

Because thulium (Tm) radiates many bright line spectrums in the vicinity of the peak wavelength of the luminosity characteristic curve during discharging and has the emission peak that coincides with the peak of the luminosity characteristic curve, it is therefore a luminescent metal extremely effective to contribute to an improvement in luminous efficacy. However, though these metal halides are halides of metals that primarily contribute to light emission, they each have a function of raising lamp voltage in a mercury-free state. For this, the amount of the metal halide primarily forming lamp voltage to be sealed can be reduced. Then, as a result, the defects (increase in color deviation) generated along with relatively excess amount of the lamp voltage-forming metal halide to be sealed can be avoided. Holmium also has the characteristics analogous to the above characteristics of thulium.

In this case, the metal that primarily contributes to light emission is generally metals which clearly contribute to the emission of the high-pressure discharge lamp whether or not it has a function of forming lamp voltage. Therefore, the metals that contribute to light emission are also luminescent metals excluding metal halides that primarily contribute to the formation of lamp voltage as will be described later. However, thulium and holmium each correspond to the metal that contributes to light emission since they emit much light in the visible region as described above and also exerts a lamp voltage-forming action in addition to the above function.

Also, in the preferred aspect of the present invention in which a halide of at least one of thulium (Tm) and holmium (Ho) is contained as the main component of the metal halide that primarily contributes to light emission and the rare gas primarily containing xenon is sealed at a pressure of 1 to 3 atm at 25° C., a variation in the chromatic deviation duv., at the rise of a light flux is very small and therefore, this aspect is preferable. Also, in this aspect, the quantity of emission in the blue region is more outstandingly reduced than in the case where the seal pressure of the rare gas primarily containing xenon is higher than the above range and therefore, the luminous efficacy becomes high. Also, the quantity of emission in the blue region is not too more reduced than in the case where the seal pressure is lower than the above range, and therefore, the chromatic deviation is not so much impaired as to be lower than the practical level.

Moreover, when halides of thulium (Tm) and holmium (Ho) are sealed as the metal halide that primarily contributes to light emission, the total amount of these metals is preferably 35% by mass or more based on the total amount of metal halides that primarily contribute to light emission, that is, all metal halides excluding the metal halides that primarily contribute to the formation of lamp voltage which will be described later. When the amount of thulium (Tm) and holmium (Ho) is in this range, these metals develop the function of raising the lamp voltage to a sufficiently practical level, with the result that a high luminous efficacy is obtained. For this, even if the amount of the lamp voltage-forming metal halide, such as ZnI₂ to be sealed is reduced to ⅕ the conventional amount, the same lamp voltage as in the case where the amount is not reduced can be obtained. Because the chromatic deviation is increased with increase in the amount of the lamp voltage-forming metal halides to be sealed, the chromatic deviation is significantly improved by the reduction in the amount of the lamp voltage-forming metal halides to be sealed.

Moreover, when total amount of halides of thulium (Tm) and holmium (Ho) is 50% by mass or more based on the total weight of the metal halides that primarily contribute to light emission, this is more preferable because a higher lamp voltage and a higher luminous efficacy can be obtained. However, the above seal ratio exceeds 80% by mass, the ratio of halides of metals except for thulium (Tm) and holmium (Ho) to be sealed is correspondingly reduced. This brings about the result that desired white light emission is not obtained and is therefore undesirable for the purpose of obtaining white light emission. Also, when the ratio of the halides of thulium (Tm) and holmium (Ho) to be sealed is 50 to 70% by mass, a particularly high luminous efficacy is obtained.

Halides of thallium (Tl) and other metals may be optionally and selectively added as needed for the purpose of, for example, adjusting the chromaticity of emission or raising the luminous efficacy besides the purpose of obtaining white light emission. Hereinafter, major examples of the case of adding halides of other metals will be explained.

When halides of alkali metals such as sodium (Na) are sealed as the halide that primarily emits light, the sealing amount of the halides of these alkali metals is limited to 30% by mass or less based on the total amount of the halides of metals primarily emits light, whereby the lamp voltage can be kept high. Also, when this amount is designed to be 25% by mass or less, the emission of these alkali metals is weakened while the ratio of the emission of the above rare earth metals is increased in the present invention, so that the average color rendering index Ra is raised.

Next, the metal halide for forming lamp voltage will be explained. The lamp voltage-forming metal halide may be sealed in the translucent ceramics sealed container 1 according to the need. As the lamp voltage-forming metal halide, many metal halides having an ionization energy of 8 eV or more and a melting point of 500° C. or less are included.

In the present invention, an aspect in which at least one of thulium halide and holmium halide is sealed in a specified ratio and the rare gas primarily containing xenon is sealed at a pressure of 3 to 5 atm enables the formation of a desired lamp voltage, and therefore, it is unnecessary to seal the lamp voltage-forming halide. However, in the present invention, no particular limitation is imposed on the amount of at least one of thulium halide and holmium halide to be sealed and also, the rare gas primarily containing xenon at 1 to 5 atm at 25° C. is sealed. However, if it is necessary to form a potential gradient of 7 V/mm or more between the pair of electrodes, the lamp voltage-forming metal halide may be sealed in a prescribed amount. In this case, the lamp voltage-forming metal halide may be sealed in an amount ranging from 0.3 to 1.6 mg/cc based on the internal volume of the translucent ceramics sealed container 1.

Also, the lamp voltage-forming metal halide has a higher vapor pressure than the aforementioned halides to be sealed in the translucent ceramics sealed container 1 in the present invention, so that it works to mainly determine the lamp voltage in the high-pressure discharge lamp. Here, the description “higher vapor pressure” means that the vapor pressure during lighting is higher. However, such an excessively high vapor pressure that is obtained by mercury is not necessary. The pressure in the translucent ceramics sealed container 1 during lighting is preferably about 5 atm or less. Therefore, any metal halide may be used as the lamp voltage-forming metal halide without any particular limitation insofar as it has the above conditions.

Also, the lamp voltage-forming halide is constituted of the metal halide that primarily forms lamp voltage and for example, halides of one or two or more metals selected from the group consisting of magnesium (Mg), iron (Fe), cobalt (Co), chromium (Cr), zinc (Zn), nickel (Ni), manganese (Mn), aluminum (Al), antimony (Sb), beryllium (Be), rhenium (Re), gallium (Ga), titanium (Ti), zirconium (Zr) and hafnium (Hf) may be primarily used. Almost of these metal halides each have a lower vapor pressure than mercury and have a narrower control range of lamp voltage than mercury.

Next the rare gas will be explained. The reason why as the rare gas, one primarily containing xenon (Xe) at a pressure of 1 to 5 atm at 25° C. is sealed is that the present invention is made on the premise that the starting voltage is dropped to obtain interchangeability with high-pressure discharge lamps, lighting devices and wiring for general lighting equipment containing mercury. The pressure of the rare gas is preferably 1 to 3 atm.

The description “primarily containing xenon” means that the volume of xenon is 80% or more. Examples of the rare gas miscible with xenon include argon (Ar), krypton (Kr) and neon (Ne).

Explanations will be furnished as to mercury. The present invention relates to a high-pressure discharge lamp freed of mercury and therefore, no mercury is sealed.

When the seal pressure of xenon in the ionization medium is relatively lower though it is in an allowable range in the present invention, the starting voltage is relatively dropped and therefore, the high-pressure discharge lamp can be started by applying a starting high voltage of 5 kV or less in the case of installing only the proximity conductor. When the seal pressure of rare gas is relatively higher though it is in an allowable range, on the other hand, the starting pressure is relatively higher and therefore, if the proximity conductor and the ultraviolet radiation means are combined, the high-pressure discharge lamp can be started by applying a starting high voltage of 5 kV or less. In this case, besides the above starting auxiliary means, other starting auxiliary means may be used together according to the need.

The starting auxiliary means is installed in the external tube 12 and is a means for aiding start so as to initiate discharge of the ionization medium in the luminescent tube 11 when starting high voltage is applied across the pair of electrodes 2 disposed in the translucent ceramics sealed container 1. As the starting auxiliary means, the proximity conductor 59 and the ultraviolet enhancer 14 are provided in this embodiment. However, only the proximity conductor 59 may be adopted. Also, a known other starting auxiliary means such as a starter may be used together according to the need.

One end of the proximity conductor 59 is welded to the current introducing conductor 3 on the lower side of the luminescent tube 11 in FIG. 8. Then, the intermediate part of the proximity conductor 59 is wound around the translucent ceramics sealed container 1 in the vicinity of the boundary between the lower small-diameter cylinder part 1b and the enclosed part 1a to form the ring part 23a and further extended upward along the direction of the tube axis in close contact with the outer periphery of the enclosed part 1a. Also, the top of the proximity conductor 59 is wound around the translucent ceramics sealed container 1 in the vicinity of the boundary between the upper small-diameter cylinder part 1b and the enclosed part 1a to form the ring part 23b which is the end of the proximity conductor 59.

Then, the proximity conductor 59 is disposed so as to form a large potential gradient in a short distance from the other electrode 2 disposed above and facing the top of the proximity conductor 59. When the proximity conductor 59 is disposed, the starting of the high-pressure discharge lamp is promoted because dielectric breakdown is easily developed when starting high-voltage is applied. When the high-pressure discharge lamp starts, the glow discharge generated in the luminescent tube is further transferred to arc discharge to short the proximity conductor 59 by the luminescent tube 11 and therefore, there is no hindrance to lighting of the high-pressure discharge lamp.

The ultraviolet radiation discharge tube is an ultraviolet enhancer 14 and has a structure in which the top of one conductor 24 is inserted and sealed in a small ultraviolet transmittable sealed container to form an internal electrode. One conductor 24 is welded to the current introducing conductor 3 disposed on the lower part of the luminescent tube 11 in FIG. 8. Then, other conductor 12 embracing an ultraviolet transmittable sealed container is welded to the support frame 26 of the luminescent support member 16 which will be described later to form an external electrode. Accordingly, the ultraviolet enhancer 14 is connected in parallel to the luminescent tube 11. Ultraviolet radiating rare gas and the like are sealed in the ultraviolet transmittable sealed container.

Then, when starting high voltage is applied across the pair of electrodes 2 prior to the starting of the high-pressure discharge lamp, discharge is first initiated and the generated ultraviolet rays are irradiated to the vicinity of the electrode disposed on the lower side of the luminescent tube 11. The ionization medium in the luminescent tube 11 is thereby excited to make the starting easy.

Then, the ultraviolet enhancer 14 starts to generate ultraviolet rays at the starting of the high-pressure discharge lamp and the produced ultraviolet rays are irradiated to the vicinity of one electrode of the luminescent tube 11. As a result, electrons are emitted from the electrode and the like and constitute initial electrons to promote the starting of the high-pressure discharge lamp. When the high-pressure discharge lamp starts, the ultraviolet enhancer is shorted by the arc discharge generated in the luminescent tube 11 and therefore, there is no hindrance to lighting.

It is to be noted that the starter has a structure provided with a switching means such as a glow starter, bimetal switch or nonlinear capacitor and is disposed in the external tube. The starter carries on a rapid switching action when turning on the power to apply the starting high voltage generated in the stabilizer across the electrodes 2 of the luminescent tube 11, thereby making easy the initiation of the high-pressure discharge lamp.

Next, explanations will be furnished as to the lighting circuit 52. The lighting circuit 52 is provided with the rectifying DC power source 54, the boosting chopper circuit 55 and the inverter circuit 56 as mentioned above.

The rectifying DC power source 54 rectifies AC voltage to obtain DC voltage. DC voltage may be smoothed as desired by using a smoothing means such as a smoothing capacitor. The boosting chopper circuit 55 is used in the case of boosting the DC voltage output from the rectifying DC power source 54 to apply the voltage to the inverter circuit 56. Therefore, the boosting chopper circuit 55 may be used according to the need.

The inverter circuit 56 is a circuit means that lights the high-pressure discharge lamp 51 and for example, a full-bridge type inverter circuit may be used as the inverter circuit 56. Then, the inverter circuit 56 is provided with an input terminal connected to the output terminal of the boosting chopper circuit 55 and also with a pair of output terminals 58a and 58b. The output terminal 58a has relatively stable potential and is connected to a first electrode 60a (below in FIG. 8) to which the base end of the proximity conductor (starting auxiliary conductor) 59 of the high-pressure discharge lamp 51 is connected. On the other hand, the output terminal 58b has relatively unstable potential and is connected to a second electrode 60b above and facing the top of the proximity conductor 59 through the wall surface of the translucent sealed container 1.

The pulse voltage generating circuit 53 is interposed between the lighting circuit 52 and the high-pressure discharge lamp 51 and operated by the AC output of the lighting circuit 52 as the power source at the start of the high-pressure discharge lamp 51 to output pulse voltage synchronously with the AC output voltage, thereby applying the pulse voltage to the pair of electrodes 60a and 60b of the high-pressure discharge lamp 51. When the high-pressure discharge lamp 51 starts to light, the pulse voltage generating circuit 53 automatically stops operating because the voltage across the input terminals of the pulse voltage generating circuit 53 is dropped to the terminal voltage of the high-pressure discharge lamp 51. In the present invention, the pulse voltage generating circuit 53 may be omitted in the case where the lighting circuit 52 can supply the voltage required to start the high-pressure discharge lamp 51.

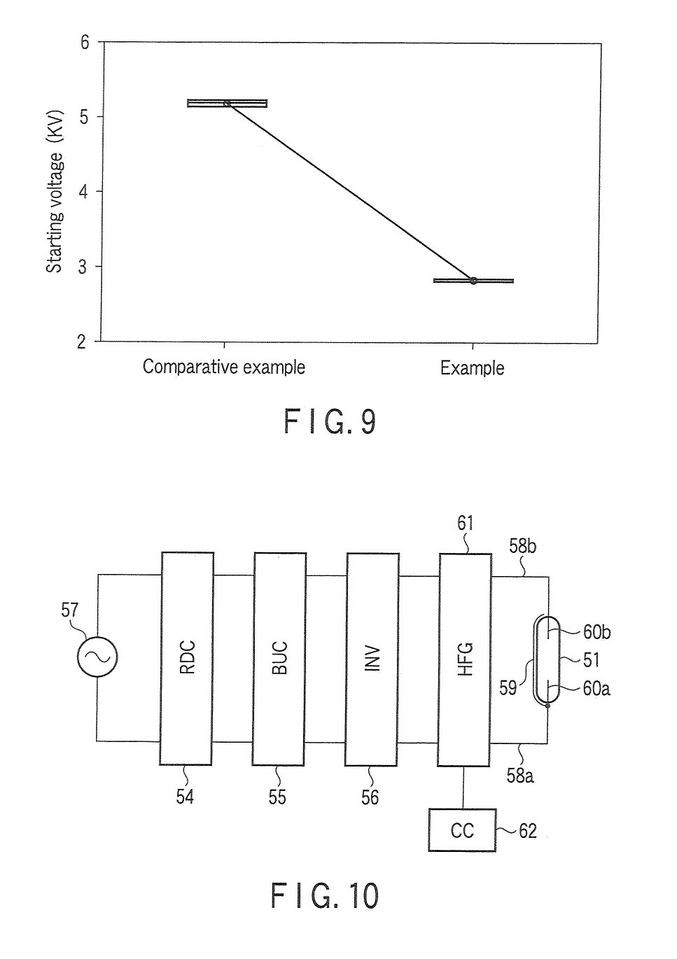

In the fourth embodiment, the high-pressure discharge lamp 51 starts to light when the starting voltage to be applied to the pair of electrodes 60a and 60b of the high-pressure discharge lamp 51 reaches about 2 to 3 kV at the start of lighting. When the same high-pressure discharge lamp as that used in this embodiment is inversely connected, the starting voltage becomes 5 to 6 kV. In the example of this embodiment, the starting voltage was about 2.8 kV as shown on the right side in FIG. 9. On the other hand, in the comparative example, the starting voltage was about 5.2 kV as shown on the left side in FIG. 9. The comparative example has the same specification as this embodiment except that the electrode (lower side in FIG. 8) to which the base end of the proximity conductor 59 is connected is connected to the output terminal 58b of the unstable potential side of the inverter circuit 56.

### Fifth Embodiment

The fifth embodiment of the present invention will be explained with reference to FIG. 8. The same parts as those in FIG. 8 are designated by the same reference numerals and explanations of these parts will not be repeated here.

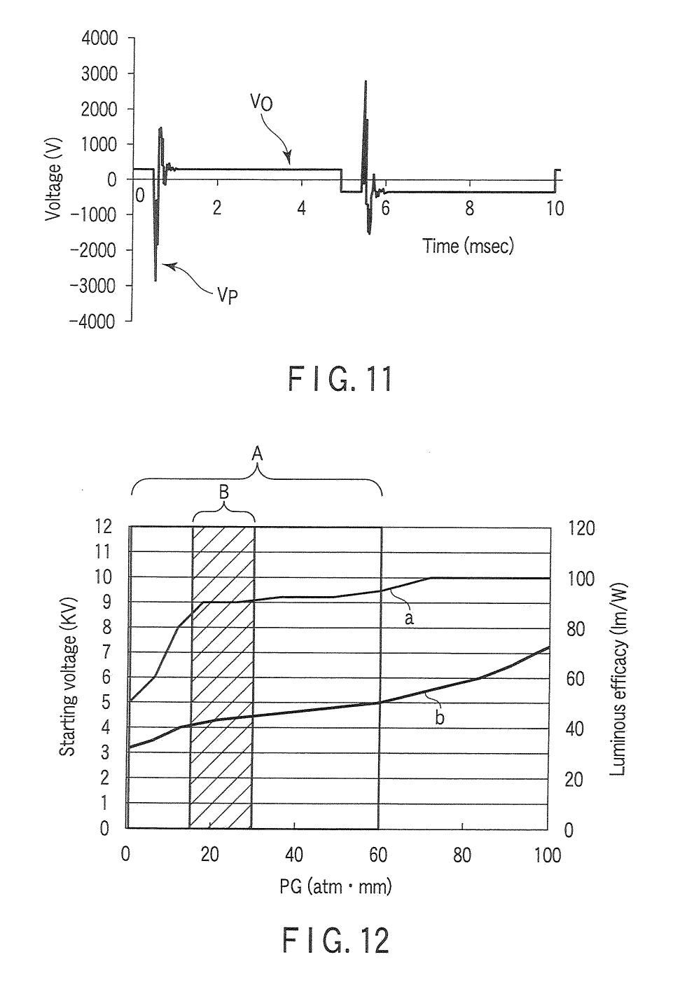

FIG. 11 is a waveform diagram showing the waveform of the applied voltage at the start of lighting in the fifth embodiment of a high-pressure discharge lamp lighting system according to the present invention. In FIG. 11, the abscissa is the time (msec.) and the ordinate is the voltage (V).

In the fifth embodiment, the peak value of the pulse voltage Vₚ has a polarity inverse to that of AC voltage waveform V₀ which is the output from the lighting circuit 52. The lower electrode 60a to which the base end of the proximity conductor 59 of the high-pressure discharge lamp 51 is connected is connected to the output terminal 58b of the unstable side of the lighting circuit 52 in FIG. 8. On the other hand, the electrode 60a disposed below and facing the top of the proximity conductor 59 through the wall surface of the translucent sealed container 1 is connected to the output terminal 58a of the stable side of the lighting circuit 52 in FIG. 8. Then, the starting voltage was about 3.3 kV.

### Sixth Embodiment

The sixth embodiment of the present invention will be explained with reference to FIG. 10. FIG. 10 is a circuit block diagram in the sixth embodiment of a high-pressure discharge lamp lighting system according to the present invention. The same parts as those in FIG. 8 are designated by the same reference numerals and explanations of these parts will not be repeated here.

The sixth embodiment is provided with a high-frequency voltage generating circuit 61 and its control means 62 disposed in place of the pulse voltage generating circuit 53 in the fourth and fifth embodiments.

The high-frequency voltage generating circuit 61 generates high-frequency voltage, its frequency is variable at least in two stages of high and low, to apply this voltage across the pair of electrodes 60a and 60b of the high-pressure discharge lamp 51 at the start of the high-pressure discharge lamp 51. A first frequency is designed to be in a range from hundreds of kHz to several MHz. A second frequency is designed to be in a range from several kHz to hundreds of kHz. Then, it is so designed that there is a difference of at least one digit or more and preferably two digits or more in frequency between the first and second frequencies. The control means 62 switches the number of high frequencies generated from the high-frequency voltage generating circuit 61 at specified time intervals under control.

According to the sixth embodiment, switching action from the starting condition to the major discharge between the pair of electrodes is promoted, with the result that the starting characteristics of the high-pressure discharge lamp 51 are improved.

### Seventh Embodiment

The seventh embodiment of the present invention will be explained. This embodiment has the same basic structures as those of the high-pressure discharge lamp of FIG. 1 and luminescent tube of FIG. 4. Only different points will be explained. Also, the same parts as those shown in FIG. 1 and FIG. 4 are designated by the same reference numerals to explain.

The high-pressure discharge lamp is 100 W-class rated lamp power type as mentioned above and is provided with the luminescent tube 11, external tube 12, proximity conductor 13, ultraviolet radiation discharge tube 14, protective glass tube 15, luminescent tube support member 16, getter 17 and cap 18. The luminescent tube 11 includes the translucent ceramics sealed container 1, pair of electrodes 2, pair of current introducing conductors 3, pair of seal materials 4 and an ionization medium as shown in FIG. 1.

The seal material 4 is made of a melt/solidified body of flit glass, that is, a ceramics compound. A seal material penetrates into the small-diameter cylinder part 1b and is filled in the clearance between the seal part 3a of the current introducing conductor 3 positioned in the small-diameter cylinder part 1b and the inner surface of the small-diameter cylinder part 1b. Also, the seal material 4 surrounds the seal part 3 so as to prevent the surface of the seal parts 3a from being exposed to the inside of the translucent ceramics sealed container 1.

The ionization medium is made of a metal halide and rare gas. The metal halide contains at least a metal halide that primarily contributes to light emission. In this embodiment, as the metal halide that primarily contributes to light emission, a halide of at least one of rare earth metals, for example, thulium (Tm) and holmium (Ho) is sealed. When thallium (Tl) is sealed besides the above metals, the blue light emission limiting phenomenon can be efficiently reduced if the amount of thallium (Tl) is limited to less than 0.8 mg/cc based on the internal volume of the translucent ceramics sealed container 1. Also, in this embodiment, the metal halide that primarily forms lamp voltage is contained but no mercury is contained.

The starting gas is constituted of rare gas primarily containing xenon, when the seal pressure of the starting gas is P (atm) at ambient temperature and the inter-electrode distance is G (mm), the product PG satisfies the equation, 3≦PG≦60.

In this embodiment, the potential of an electrode (though not shown) on the upper side in FIG. 1 is applied to the starting auxiliary conductor 13 in the vicinity of an electrode on the lower side in FIG. 1 through the translucent ceramics sealed container 1. Therefore, a large potential gradient is produced between the ring part 23b and the lower electrode. For this, when the starting high voltage as high as 5 kV or less is applied across the pair of electrodes 2, the starting of the high-pressure discharge lamp is promoted.

In the ultraviolet enhancer 14, the top of one conductor 11 is sealed and inserted into a small ultraviolet transmittable external enclosed container to form an internal electrode. The one conductor 24 is welded to the current introducing conductor 3 on the lower side of the luminescent tube 11 in FIG. 4. Then, the other conductor 25 that holds and supports the sealed container 1 is welded to the support frame 26 of the luminescent tube support member 16 which will be described later to form an external electrode. Therefore, the ultraviolet enhancer 14 is connected in parallel to the luminescent tube 11. Ultraviolet radiating rare gas and nitrogen are sealed in the sealed container 1.

When starting high voltage is applied across the pair of electrodes 2 prior to the starting of the high-pressure discharge lamp, discharge is first initiated and the generated ultraviolet rays are irradiated to the vicinity of the electrode disposed on the lower side of the luminescent tube 11. The ionization medium in the luminescent tube 11 is thereby excited to make the starting easy.

FIG. 12 is a graph showing the results when high-pressure discharge lamps variously changed in the seal pressure of starting gas and in the inter-electrode distance are manufactured based on one embodiment of the present invention to measure the correlation between the seal pressure of the starting gas and the inter-electrode distance and the relation between the starting voltage and the luminous efficacy. In FIG. 12, the abscissa is PG (atm-mm) and the ordinate is the starting voltage (kV) on the left and luminous efficacy (lm/W) on the right. Also, the curve a indicates the starting voltage and the curve b indicates the luminous efficacy in FIG. 12.

As is understood from FIG. 12, the luminous efficacy becomes 50 lm/W or more when PG is 3 or more. However, when PG is less than 3, the luminous efficacy becomes less than 50 lm/W. Also, when PG is 15 or more, a luminous efficacy of 85 or more can be obtained. When PG is 60 or less on the other hand, the starting voltage exceeds 5 kV and therefore, the object of the present invention cannot be attained. Also, when PG is 15 to 30, the starting voltage is 5 kV or less and a luminous efficacy as high as 85 lm/W or more is obtained.

It is found from overall rating of the above results that when PG is in a range from 3 to 60 (zone A), the starting voltage is 5 kV or less and the luminous efficacy is 50 lm/W or more, so that the object of the present invention can be attained. Also, it is found that more preferable effect is obtained when PG is in a range from 15 to 30 (zone B).

### Example 2

Next, a metal halide lamp according to this Example 2 will be explained.

Translucent ceramics sealed container: polycrystalline alumina ceramics integrated molding, maximum inside diameter: 5 mm, discharge space length: 9 mm, wall thickness: 0.5 mm, total length; 34 mm, internal volume: 0.12 cc

Pair of electrodes: inter-electrode distance: 6.4 mm

Ionization medium: Tml₃-Nal-Znl₂ (ratio by mass: 3:1:0.1) 4.1 mg, Xe: 2.5 atm

Stating auxiliary body: ultraviolet enhancer, proximity conductor

Starting voltage: 3.8 kV

Glow arc transfer time: 0.1 sec. (stabilizer starting pulse voltage: 4 kV, open applied voltage: 300 V)

Electrical characteristics: lamp voltage 40 V, lamp power 30 W, (as the stabilizer, a private stabilizer is used)

Luminescent characteristics: luminous efficacy: 86 lm/W

A recessed type ceiling down light as one embodiment of the lighting equipment of the present invention has the structure shown in FIG. 7. As the high-pressure discharge lamp 41, the above metal halide lamp is attached.

1. A high-pressure discharge lamp comprising:
a translucent ceramics sealed container provided with an enclosed part with a discharge space formed therein;
a pair of electrodes disposed inside of both end part of the translucent sealed container; and
an ionization medium having a structure including a metal halide that primarily emits light, a starting gas and substantially no mercury, the metal halide that primarily emits light including 30% by mass or more of a halide of at least one lanthanoid type rare earth metal and the starting gas having a pressure P (atm) satisfying the equation, 1≦P≦20, the ionization medium being sealed in the translucent ceramics sealed container, wherein the ratio D/G satisfies the equation, 0.3≦D/G≦2.4 when the maximum inside diameter of the translucent ceramics sealed container is D and the inter-electrode distance is G.

2. The high-pressure discharge lamp according to claim 1 further comprising:
a starting auxiliary conductor unitarily including two ends and an intermediate portion between the two ends, one of the two ends being electrically connected to one of the electrodes of a luminescent tube having an enclosed part and two small-diameter cylinder parts oppositely extending from the enclosed part, the intermediate portion extending from the one of the electrodes over the enclosed part of the luminescent tube to the other of the electrodes, and the other end capacitively coupling to the other of the electrodes of the luminescent tube through one of the small-diameter cylinder parts enclosing the other of the electrodes.

3. The high-pressure discharge lamp according to claim 2 further comprising:
an ultraviolet enhancer disposed close to the side of the capacitive coupling part between the other electrode of the luminescent tube and the starting auxiliary conductor.

4. The high-pressure discharge lamp according to claim 3, wherein the ultraviolet enhancer is disposed in the condition that the side of at least a part of its luminescent length part is within a distance of 7 mm from the capacitive coupling part.

5. The high-pressure discharge lamp lighting system comprising:
the high-pressure discharge lamp as claimed in claim 2; and
a lighting circuit provided with a pair of output terminals of which one is a stable potential side and the other is an unstable potential side wherein the stable potential side output terminal is connected to a first electrode of the high-pressure discharge lamp and the unstable potential side output terminal is connected to a second electrode to light the high-pressure discharge lamp.

6. A high-pressure discharge lamp lighting system comprising:
the high-pressure discharge lamp as claimed in claim 1;
a lighting circuit provided with an AC voltage generating circuit and a pair of output terminals which output AC voltage to apply the voltage across a first electrode and a second electrode of the high-pressure discharge lamp, thereby lighting the high-pressure discharge lamp; and
a pulse voltage generating circuit which generates pulse voltage having a polarity inverse to that of AC voltage synchronously with the AC output voltage of the lighting circuit at the start of the high-pressure discharge lamp to apply the pulse voltage to the high-pressure discharge lamp.

7. The high-pressure discharge lamp according to claim 1, wherein the starting gas of the ionization medium primarily contains xenon at a pressure of 1 to 10 atm at 25° C.; and
when the seal pressure of xenon is P (atm) and the inter-electrode distance is G (mm), the product PG satisfies the equation, 3≦PG≦60, and the dielectric breakdown voltage in the translucent ceramics sealed container is 5 kV or less.

8. Lighting equipment comprising:
a lighting equipment body;
the high-pressure discharge lamp as claimed in claim 1, the discharge lamp being disposed in the lighting equipment body; and
a high-pressure discharge lamp lighting device which has the function of generating starting high voltage at the start of lighting to start and to light the high-pressure discharge lamp.
